(19) United States
(12) Patent Application Publication
(10) Pub. No.: US 2011/0291532 A1
(43) Pub. Date: Dec. 1, 2011

(54) CORELESS ELECTROMECHANICAL DEVICE

(75) Inventors: Kesatoshi TAKEUCHI, Shiojiri (JP); Kazuyoshi NAKAMURA, Azumino (JP)

(73) Assignee: SEIKO EPSON CORPORATION, Tokyo (JP)

(21) Appl. No.: 13/008,101

(22) Filed: Jan. 18, 2011

(30) Foreign Application Priority Data
May 26, 2010 (JP) 2010-120516

(51) Int. Cl. H02K 1/12; H02K 11/00

(52) U.S. Cl. 310/68 B; 310/216.002

(57) ABSTRACT

A coreless electromechanical device having a first and second member which are movable relative to each other, includes: a permanent magnet disposed on the first member; an air-cored electromagnetic coil disposed on the second member; and a coil back yoke which, being disposed on the second member, has a stacked structure, wherein the electromagnetic coil is disposed between the permanent magnet and coil back yoke, the electromagnetic coil has an active coil region, in which a force causing the first member to move relatively in a movement direction is generated in the electromagnetic coil, and coil end regions, and the coil back yoke covers the active coil region, but does not cover the coil end regions.

### BACKGROUND

1. Technical Field

The present invention relates to a coreless electromechanical device.

2. Related Art

A motor generates a drive force using a Lorentz force between a permanent magnet and an electromagnetic coil (for example, JP-A-2008-159847). As an electric coreless motor, one including a magnetic sensor in order to detect a position in a rotation direction of a rotor is known (for example, JP-A-2007-267565).

With a coreless electromechanical device, as it does not have a core which causes magnetic fluxes of an electromagnetic coil to converge, it has been difficult to realize a large torque. Meanwhile, as a torque and a current are proportional to each other, a large current flows through the electromagnetic coil when a large torque occurs. That is, the strength of a magnetic field generated by the magnetic coil changes in accordance with the size of a torque output by a motor. For this reason, there has been a danger that a distortion occurs in the output of the magnetic sensor, due to the change of the strength of the magnetic field generated by the electromagnetic coil, depending on the position of the magnetic sensor. Also, there has been a danger that when the magnetic sensor is disposed in a position which is not affected by the strength of the magnetic field generated by the electromagnetic coil, the magnet and magnetic sensor come closer to each other, and the output of the magnetic sensor is saturated. When the output of the magnetic sensor is saturated, it is difficult to cause the coreless electromechanical device to operate efficiently, and it is difficult to increase the torque.

### SUMMARY

An advantage of some aspects of the invention is to cause a large torque to occur in a coreless electromechanical device, and furthermore, to curb an occurrence of a distortion or saturation of the output of a magnetic sensor when a high torque occurs.

### Application Example 1

This application example is directed to a coreless electromechanical device having a first and second member which are movable relative to each other including a permanent magnet disposed on the first member, an air-cored electromagnetic coil disposed on the second member, and a coil back yoke which, being disposed on the second member, has a stacked structure. The electromagnetic coil is disposed between the permanent magnet and coil back yoke, the electromagnetic coil has an active coil region, in which a force causing the first member to move relatively in a movement direction is generated in the electromagnetic coil, and coil end regions, and the coil back yoke covers the active coil region, but does not cover the coil end regions.

According to the application example, as it is possible to curb an occurrence of an eddy current, it is possible to reduce a loss due to an eddy-current loss, and realize a large torque.

### Application Example 2

With the coreless electromechanical device according to the application example 1, it is preferable that the active coil region is a projection region when the permanent magnet is projected toward the electromagnetic coil from the permanent magnet.

According to the application example, as it is possible to effectively use magnetic fluxes of the permanent magnet, it is possible to reduce the loss, and realize the large torque.

### Application Example 3

With the coreless electromechanical device according to the application example 1 or 2, it is preferable that the coil back yoke has a plurality of steel plate materials stacked in a direction perpendicular to the movement direction of the first member.

According to the application example, as the coil back yoke has the stacked steel plate materials having a layered structure parallel to a movement direction of a movable body, it is possible to curb a generation of an eddy current in a direction perpendicular to the movement direction.

### Application Example 4

With the coreless electromechanical device according to the application example 3, it is preferable that the thickness of the steel plate materials is 0.1 mm or less.

According to the application example, as the thickness of the stacked steel plate materials is 0.1 mm or less, it is easy to curb the occurrence of the eddy current.

### Application Example 5

With the coreless electromechanical device according to the application example 3, it is preferable that the thickness of the steel plate materials is approximately 0.1 mm.

According to the application example, the thickness of the stacked steel plate materials may be approximately 0.1 mm.

### Application Example 6

With the coreless electromechanical device according to the application example 1 to 5, it is preferable that the first member further has a magnetic member, and the second member further has a magnetic sensor which detects the size of magnetic fluxes generated by the permanent magnet, and that the magnetic sensor is disposed in a position in which a direction of magnetic flux lines generated by the magnetic coil and a direction of magnetic flux lines detected by the magnetic sensor are perpendicular to each other, and the magnetic member is disposed between the magnetic sensor and permanent magnet.

According to the application example, as the magnetic sensor detects no change of magnetic fluxes due to a current flowing through the electromagnetic coil, it is difficult for the output of the magnetic sensor to be distorted, and as the magnetic member is disposed between the magnetic sensor and magnet, it is difficult for the output to be saturated.

### Application Example 7

With the coreless electromechanical device according to the application example 6, it is preferable that the first member and second member have a concentric cylindrical form with a rotating shaft of the first member as the center, the permanent magnet and electromagnetic coil are disposed, opposed to each other, on the opposed cylindrical surfaces of the first member and second member, and the magnetic member is disposed on an end face of the permanent magnet in a direction parallel to an axial direction of the rotating shaft.

The permanent magnet and electromagnetic coil may be arranged in a radial direction with respect to the rotating shaft.

### Application Example 8

With the coreless electromechanical device according to the application example 7, it is preferable that a position in which the magnetic sensor is disposed is between a coil end of the electromagnetic coil and the rotating shaft, and on a radial line extended down to the rotating shaft from the coil end.

According to the application example, the magnetic sensor detects no change of magnetic fluxes due to the current flowing through the electromagnetic coil.

### Application Example 9

With the coreless electromechanical device according to the application example 1 to 5, it is preferable that the permanent magnet includes side yokes at either end in a direction perpendicular to each of the direction toward the electromagnetic coil from the permanent magnet and the movement direction.

According to the application example, it is possible to curb a leakage of magnetic fluxes in the direction of each side surface of the magnet owing to the side yokes.

### Application Example 10

With the coreless electromechanical device according to the application example 1 to 5 or 9, it is preferable that the first member is a rotor having the permanent magnet, and the second member is a stator having the air-cored electromagnetic coil, the coil back yoke, and a casing, and that the rotor and stator have a concentric cylindrical form with a rotating shaft of the rotor as the center, the permanent magnet and electromagnetic coil are disposed, opposed to each other, on the opposed cylindrical surfaces of the rotor and stator, and the coil back yoke is provided in a projection region of the casing when the permanent magnet is projected in the direction toward the electromagnetic coil from the permanent magnet, but the coil back yoke is not provided outside the projection region of the casing.

According to the application example, it is possible to curb the occurrence of the eddy current, and it is possible to reduce the loss due to the eddy-current loss.

### Application Example 11

With the coreless electromechanical device according to the application example 10, it is preferable that the projection direction is a radial direction centered on the rotating shaft.

### Application Example 12

With the coreless electromechanical device according to the application example 10 or 11, it is preferable that the coil back yoke has a cylindrical form, and the cylindrical form is formed by stacking holed discs.

According to the application example, the coil back yoke is formed into a cylindrical form by stacking the holed discs. As the eddy current is generated along the surfaces of the holed discs, it is possible to reduce the eddy current.

### Application Example 13

With the coreless electromechanical device according to the application example 10 or 11, it is preferable that the coil back yoke has a cylindrical form, and the cylindrical form is formed by coiling a plate having a thickness smaller than its width in a spiral form in a direction of the thickness.

According to the application example, as the coil back yoke is formed by coiling the plate in the spiral form, it is not necessary to bring the holed discs together in a cylindrical form, facilitating a molding and manufacturing.

### Application Example 14

With the coreless electromechanical device according to the application example 12 or 13, it is preferable that the coil back yoke has a cutaway portion in a side surface of the cylindrical form on the electromagnetic coil side.

According to the application example, as the coil back yoke has the cutaway portion in the side surface of the cylindrical form on the electromagnetic coil side, it is possible to curb the eddy current owing to the cutaway portion.

### Application Example 15

With the coreless electromechanical device according to the application example 14, it is preferable that the cutaway portion reaches a side surface of the cylindrical form on the side opposite to the electromagnetic coil.

According to the application example, as the cutaway portion reaches the side surface of the cylindrical form on the side opposite to the electromagnetic coil, the eddy current is highly effectively curbed.

### Application Example 16

With the coreless electromechanical device according to the application example 6, it is preferable that the first member and second member have a first and second disc form perpendicular to the rotating shaft of the first member, the permanent magnet and electromagnetic coil are disposed, opposed to each other, on the opposed disc surfaces of the first member and second member, and the magnetic member is disposed on an end face of the permanent magnet in a direction perpendicular to the axial direction of the rotating shaft.

The magnet and electromagnetic coil may be arranged in a direction parallel to the rotating shaft.

### Application Example 17

With the coreless electromechanical device according to the application example 16, it is preferable that a position in which the magnetic sensor is disposed is on a straight line drawn parallel to the rotating shaft from the coil end of the electromagnetic coil.

According to the application example, the magnetic sensor detects no change of magnetic fluxes due to the current flowing through the electromagnetic coil.

### Application Example 18

With the coreless electromechanical device according to claim 1 to 5 the application example 16, 17, it is preferable that the first member is a rotor having the permanent magnet, and the second member is a stator having the air-cored electromagnetic coil, the coil back yoke, and a casing, and that the rotor and stator have a first and second disc form perpendicular to a rotating shaft of the rotor, the permanent magnet and electromagnetic coil are disposed, opposed to each other, on the opposed disc surfaces of the rotor and stator, and the coil back yoke is provided in a projection region of the casing when the permanent magnet is projected in the direction toward the electromagnetic coil from the permanent magnet, but the coil back yoke is not provided outside the projection region of the casing.

According to the application example, the invention can be applied to an electromechanical device of a so-called axial gap type.

### Application Example 19

With the coreless electromechanical device according to the application example 18, it is preferable that the projection direction is a direction parallel to the rotating shaft.

### Application Example 20

With the coreless electromechanical device according to the application example 16 to 19, it is preferable that the coil back yoke has a holed disc form, and the holed disc form is formed by coiling a long and thin flat plate in a spiral spring form.

According to the application example, as the holed disc form of the coil back yoke is formed by coiling the long and thin flat plate in the spiral spring form, it is easy to curb an occurrence of the eddy current in a radial direction of the holed disc.

### Application Example 21

With the coreless electromechanical device according to the application example 20, it is preferable that the holed disc form has a cutaway portion in a surface on the electromagnetic coil side.

According to the application example, as the coil back yoke has the cutaway portion, it is possible to curb the eddy current owing to the cutaway portion.

### Application Example 22

With the coreless electromechanical device according to the application example 21, it is preferable that the cutaway portion reaches a surface of the holed disc form on a side opposite to the electromagnetic coil.

According to the application example, as the cutaway portion reaches a surface of the holed disc form on a side opposite to the electromagnetic coil, the eddy current is highly effectively curbed.

### Application Example 23

With the coreless electromechanical device according to the application example 1 to 22, it is preferable that the coil back yoke is exposed to the external air.

According to the application example, even in the event that heat is generated in the coil back yoke due to the eddy-current loss, it is possible to easily release the heat.

### Application Example 24

With the coreless electromechanical device according to the application example 1 to 23, it is preferable that the coil back yoke contains 5 weight percent or more of silicon.

According to the application example, as the coil back yoke contains 5 or more percent by weight of silicon, it is possible to increase the density of magnetic fluxes passing through the electromagnetic coil.

### Application Example 25

With the coreless electromechanical device according to the application example 1 to 5 or 9, it is preferable that the first member has a rod-like structure having a magnet inside it, the second member, having an electromagnetic coil wound in a round direction with the first member as an axis, moves along the first member, and the coil back yoke has a stacked structure having layers parallel to the movement direction of the second member.

According to the application example, the invention can be applied to not only a rotary type motor, but also a linear motor and a shaft motor.

### Application Example 26

With the coreless electromechanical device according to the application example 6, 7, 16, 17, it is preferable that the magnetic member is provided on a side surface in the movement direction of the permanent magnet in such a way that, when the permanent magnet moves relative to the electromagnetic coil, the output waveform of the magnetic sensor becomes a waveform equivalent to a waveform wherein a back electromotive force waveform occurring in the electromagnetic coil is normalized, the magnetic sensor detects magnetic fluxes leaking from the magnetic member, and the electromagnetic coil is PWM driven in accordance with the output waveform of the magnetic sensor.

According to the application example, as the output waveform of the magnetic sensor and the waveform wherein the back electromotive force occurring in the electromagnetic coil is normalized are equivalent to each other, it is possible to efficiently drive the coreless electromechanical device.

### Application Example 27

This application example is directed to a coreless electromechanical device including a rotor having a permanent magnet and a magnetic member; a stator having an active coil region in which a force causing the rotor to rotate is generated and coil end regions, and having an electromagnetic coil which is air-cored and a magnetic sensor which detects the size of magnetic fluxes generated by the permanent magnet; a coil back yoke which covers the active coil region but does not cover the coil end regions; and a casing which surrounds the rotor, stator, and coil back yoke. The magnetic sensor is disposed in a position in which a direction of magnetic flux lines generated by the electromagnetic coil and a direction of magnetic flux lines detected by the magnetic sensor are perpendicular to each other, the magnetic member is disposed between the magnetic sensor and permanent magnet, the active coil region is a projection region when the permanent magnet is projected toward the electromagnetic coil from the permanent magnet, and the coil back yoke is formed by stacking steel plate materials with a thickness of 0.1 mm or less parallel to a rotation direction of the rotor.

According to the application example, as it is possible to curb the occurrence of the eddy current, it is possible to reduce the loss due to the eddy-current loss, and realize the large torque.

The invention can be realized in various aspects, for example, it can be realized in various aspects apart from the electromechanical device, such as a method of disposing the magnetic sensor in the electromechanical device.

### BRIEF DESCRIPTION OF THE DRAWINGS

The invention will be described with reference to the accompanying drawings, wherein like numbers reference like elements.

FIGS. 1A and 1B are illustrations showing a configuration of a coreless motor of a first embodiment.

FIGS. 2A to 2E are illustrations showing a method of manufacturing electromagnetic coils.

FIGS. 3A and 3B are illustrations showing a resin filling device for filling the electromagnetic coils with a resin.

FIGS. 4A to 4E are illustrations showing steps of firming the electromagnetic coils with the resin.

FIG. 5 is an illustration showing a configuration of a coil back yoke 115.

FIG. 6 is an illustration showing another configuration example of the coil back yoke 115.

FIG. 7 is an illustration schematically showing a measurement of an eddy current.

FIG. 8 is an illustration showing an eddy-current loss of the first embodiment.

FIGS. 9A and 9B are illustrations showing a relationship between the thickness and eddy-current loss of holed discs 115a when the coil back yoke 115 employs a stacked structure.

FIGS. 10A and 10B are illustrations showing a model of a magnetic field analysis.

FIG. 11 is an illustration showing a result of a measurement of a relationship between the distance from the back surface of permanent magnets to a magnetic sensor and the density of magnetic fluxes.

FIG. 12 is an illustration comparing the characteristics of a coreless motor according to the first embodiment and those of a cored motor which is a comparison example.

FIG. 13 is an illustration comparing a relationship in torque and rotation number between the coreless motor of the first embodiment and the cored motor of the comparison example.

FIG. 14 is an illustration comparing a relationship in torque and current between the coreless motor of the first embodiment and the cored motor of the comparison example.

FIG. 15 is an illustration comparing a relationship in torque and input power between the coreless motor of the first embodiment and the cored motor of the comparison example.

FIG. 16 is an illustration comparing a relationship in torque and output power (work) between the coreless motor of the first embodiment and the cored motor of the comparison example.

FIG. 17 is an illustration comparing a relationship in torque and efficiency (=output power/input power) between the coreless motor of the first embodiment and the cored motor of the comparison example.

FIGS. 18A and 18B are illustrations showing a second embodiment.

FIG. 19 is an illustration showing a third embodiment.

FIG. 20 is an illustration comparing the torque characteristics of a coreless motor of the third embodiment and those of a coreless motor of a comparison example.

FIGS. 21A and 21B are illustrations schematically showing a configuration of a coreless motor of a fourth embodiment.

FIG. 22 is an illustration schematically showing a relationship in position between a central portion and an electromagnetic coil.

FIG. 23 is a graph showing a relationship between the rotation number and eddy-current loss of the motor.

FIGS. 24A to 24C are illustrations showing magnetic fluxes of a magnet and the electromagnetic coil in the fourth embodiment.

FIGS. 25A to 25C are illustrations showing magnetic fluxes of a magnet and an electromagnetic coil in a heretofore known example.

FIGS. 26A to 26D are illustrations showing outputs of a magnetic sensor.

FIGS. 27A and 27B are illustrations showing Lorentz forces applied to a coil end in the fourth embodiment.

FIGS. 28A and 28B are illustrations showing a Lorentz force applied to a coil end in a heretofore known example.

FIGS. 29A to 29D are illustrations illustrating orientations of Lorentz forces applied to coil ends of opposed coils.

FIGS. 30A and 30B are illustrations showing a fifth embodiment.

FIG. 31 is an illustration showing changes in temperature of a partial casing and a full-coverage casing.

FIGS. 32A to 32C are illustrations showing a configuration of an axial gap type motor which is a sixth embodiment.

FIGS. 33A to 33E are illustration showing a seventh embodiment.

FIG. 34 is an illustration showing a manufacturing method of a coil back yoke 115.

FIGS. 35A and 35B are illustrations showing an eighth embodiment.

FIGS. 36A to 36D are illustrations showing configuration examples of a coil back yoke.

FIG. 37 is a graph showing a relationship between the rotation number and eddy-current loss of a motor in a ninth embodiment.

FIGS. 38A to 38C are illustrations showing a tenth embodiment.

FIGS. 39A and 39B are illustrations showing an eleventh embodiment.

FIGS. 40A and 40B are illustrations showing a twelfth embodiment.

FIGS. 41A to 41D are illustrations showing a thirteenth embodiment.

FIG. 42 is an illustration showing magnetic fluxes in the thirteenth embodiment.

FIGS. 43A and 43B are illustrations schematically showing a configuration of a coreless motor of a fourteenth embodiment.

FIG. 44 is an illustration showing one example of a control block of the coreless motor.

FIG. 45 is an illustration showing a projector utilizing a motor according to a modification example of the invention.

FIGS. 46A to 46C are illustrations showing a fuel cell type portable telephone utilizing a motor according to a modification example of the invention.

FIG. 47 is an illustration showing an electric bicycle (an electrically assisted bicycle) as one example of a movable body utilizing a motor/an electric generator according to a modification example of the invention.

FIG. 48 is an illustration showing one example of a robot utilizing a motor according to a modification example of the invention.

FIG. 49 is an illustration showing a railcar utilizing a motor according to a modification example of the invention.

### DESCRIPTION OF EXEMPLARY EMBODIMENTS

### First Embodiment

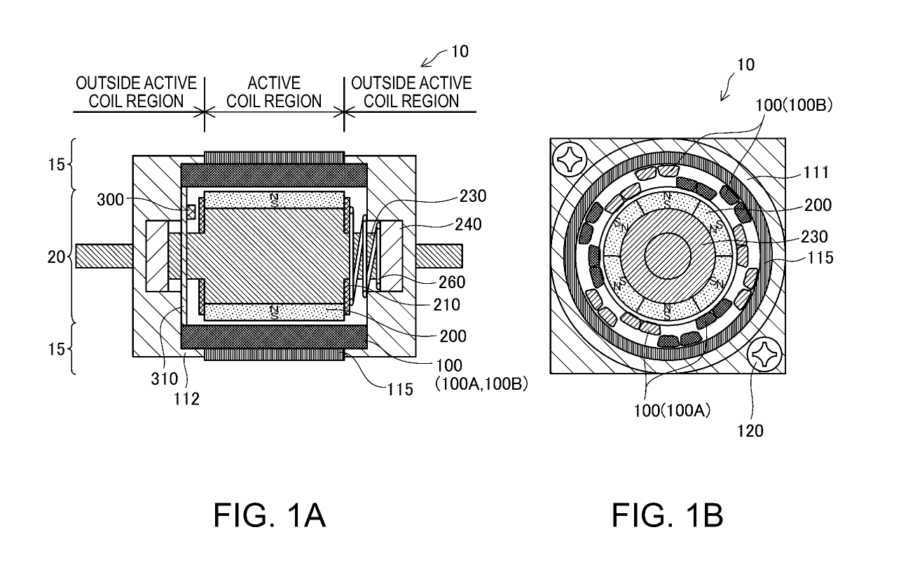

FIGS. 1A and 1B are illustrations showing a configuration of a coreless motor of a first embodiment. FIG. 1A is a section of the coreless motor 10 taken on a plane parallel to its rotating shaft, and FIG. 1B is a section of the coreless motor 10 taken on a plane perpendicular to its rotating shaft. The coreless motor 10 is an inner rotor type motor of a radial gap structure. With the coreless motor 10, a stator 15 is disposed on the outer side. An approximately cylindrical space is formed inside the stator 15, and an approximately cylindrical rotor 20 is disposed in the approximately cylindrical space.

The stator 15 includes electromagnetic coils 100, a casing 110, and a coil back yoke 115. The rotor 20 includes the rotating shaft 230 and a plurality of permanent magnets 200. The rotating shaft 230 is the central shaft of the rotor 20, and the permanent magnets 200 are disposed on the periphery of the rotating shaft 230. The permanent magnets 200 are magnetized in a radial direction toward the exterior from the center of the rotating shaft 230. Side yokes 210 are disposed on either side of the permanent magnets 200 in a direction parallel to the rotating shaft 230. The side yokes 210, being formed from a magnetic material, control a leakage of magnetic fluxes of the permanent magnets 200 in a direction parallel to the rotating shaft 230. The rotating shaft 230 is supported by bearings 240 of the casing 110.

The casing 110 has inside it an approximately cylindrical space, and a plurality of the electromagnetic coils 100 are disposed along the inner periphery of the approximately cylindrical space. In the embodiment, the electromagnetic coils 100 include electromagnetic coils 100A disposed on the inner side and electromagnetic coils 100B disposed on the outer side. In the embodiment, when it is not necessary to distinguish between the electromagnetic coils 100A and electromagnetic coils 100B, they are simply called the “electromagnetic coils 100”. The electromagnetic coils 100 are coreless (air-cored). Also, the electromagnetic coils 100 and permanent magnets 200 are disposed, opposed to each other, on the opposed cylindrical surfaces of the rotor 20 and stator 15. Herein, the length of the electromagnetic coils 100 in the direction parallel to the rotating shaft 230 is greater than the length of the permanent magnets 200 in the direction parallel to the rotating shaft 230. That is, when a projection is made in the radial direction from the permanent magnets 200, portions of the electromagnetic coils 100 are out of a projection region. The portions of the electromagnetic coils 100 out of the projection region are called “coil ends”. Herein, when the electromagnetic coils 100 are divided into the coil ends and a portion other than the coil ends, the orientation of a force generated by a current flowing through the coil ends is of a direction (the direction parallel to the rotating shaft 230) differing from a rotation direction of the rotor 20, and the orientation of a force generated by a current flowing through the portion other than the coil ends is of a direction approximately the same as the rotation direction of the rotor 20. There are two coil ends sandwiching the portion other than the coil ends, and as the forces occurring in the two coil ends are of directions opposite to each other, they balance each other out as a force applied to the whole of the electromagnetic coils 100. In the embodiment, a region which does not coincide with the coil ends is called an “active coil region”, and regions which coincide with the coil ends are called “regions outside the active coil region”. The coil back yoke 115 is provided in a portion which is on a radial direction outer side of the electromagnetic coils 100 and coincides with the active coil region. It is preferable that the coil back yoke 115 does not overlap the regions outside the active coil region. In the event that the coil back yoke 115 overlaps the regions outside the active coil region, an eddy-current loss (an iron loss) occurs in portions of the coil back yoke 115 which overlap the regions outside the active coil region, diminishing the efficiency of the coreless motor 10, and it is difficult to realize a large torque.

The casing 110 includes a cylindrically shaped portion (a side surface portion) 111 parallel to the rotating shaft 230, and disc-shaped portions (end face portions) 112 which, being disposed at either end of the cylindrically shaped portion 111, are perpendicular to the rotating shaft 230. The two disc-shaped portions 112 are disposed sandwiching the cylindrically shaped portion 111, and the two disc-shaped portions 112 and cylindrically shaped portion 111 are fixed by attachment screws 120. The cylindrically shaped portion 111 overlaps the active coil region. The cylindrically shaped portion 111 may be formed from a material with a high thermal conductivity in order to release heat generated in the coil back yoke 115. The disc-shaped portions 112 are formed from a resin.

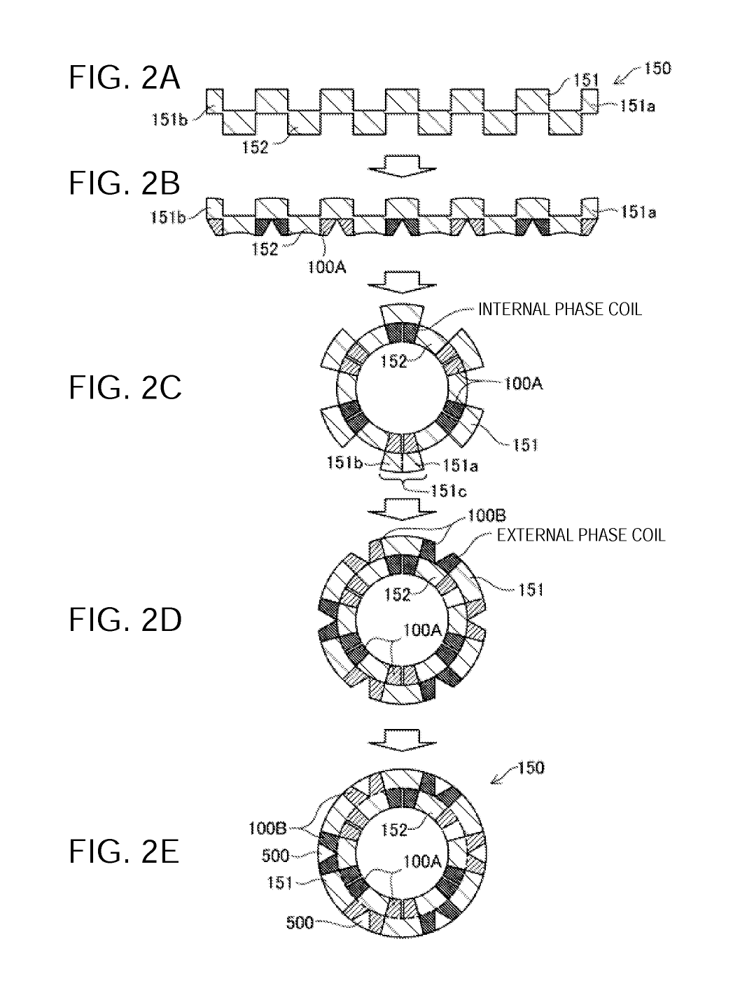

FIGS. 2A to 2E are illustrations showing an electromagnetic coil manufacturing method. In the embodiment, as the electromagnetic coils 100, coils are used wherein a plurality of electromagnetic coils are firmed with a resin, and molded into a cylinder. Each electromagnetic coil is wound in such a way as to take a normal direction of the side surface of the cylinder to be a direction of its axis, and circle around the axis. In the step shown in FIG. 2A, a plate 150 with strap-like depressions and protrusions on its front and back sides is prepared. The plate 150, being formed from a resin, can be manufactured by, for example, injection molding. The plate 150 includes protrusions 151 on the front side and protrusions 152 on the back side. The protrusions 151 and protrusions 152 are alternately disposed. Also, protrusions 151a and 151b narrower in width than the protrusions 151 are provided at either end of the front side. The sum of the widths of the protrusions 151a and 151b is the same as the width of the other protrusions 151. The individual widths of the protrusions 151a and 151b may be either the same as each other or different from one another, provided that the sum of the widths of the protrusions 151a and 151b is the same as the width of the other protrusions 151. Also, the apices of the protrusions 151 on the front side may be convex, and the apices of the protrusions 152 on the back side may be concave, as shown in FIG. 2B. The curvatures of the convexities of the apices of the protrusions 151, and of the concavities of the protrusions 152, can be set from the length from the protrusion 151a to the protrusion 151b of the plate 150, and the height of the protrusions 151 and protrusions 152.

In the step shown in FIG. 2B, a conductor is wound around each protrusion 152 on the back side, forming electromagnetic coils 100A (internal phase coils). In the step shown in FIG. 2C, the plate 150 is bent into a cylinder in such a way that the electromagnetic coils 100A are positioned on the inner side. At this time, the plate 150 is bent in such a way that the two protrusions 151a and 151b on the front side are conjoined to form one protrusion 151c. The size of the conjoined protrusion 151c is the same as the size of the other protrusions 151. Also, when the apices of the protrusions 151 on the front side are convex, and the apices of the protrusions 152 on the back side are concave, a surface formed by smoothly connecting the apices on each side forms a smooth cylindrical side surface. Provided that the cylindrical side surfaces are smooth, it is difficult for a difference in level to occur when firming the plate 150, the electromagnetic coils 100A, and electromagnetic coils 100B with a resin in a subsequent step. In the step shown in FIG. 2D, a conductor is wound around each protrusion 151 on the outer front surface of the cylinder formed from the plate 150, forming the electromagnetic coils 100B (external phase coils). In the step shown in FIG. 2E, the depressions on the inner side and outer side of the cylinder are filled with a resin 500, smoothening the inner side and outer side of the cylinder.

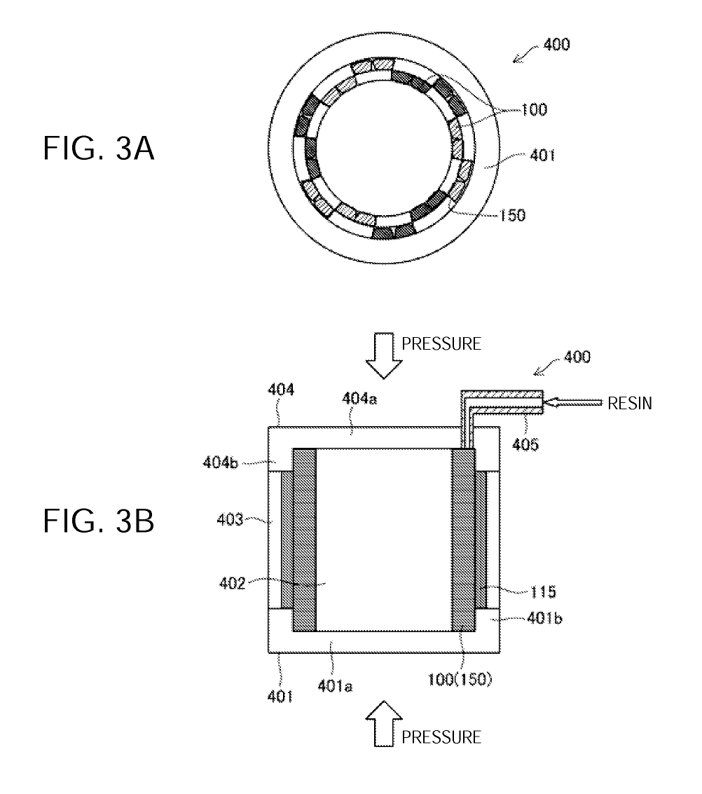

FIGS. 3A and 3B are illustrations showing a resin filling device for filling the electromagnetic coils with the resin. FIG. 3A is a bottom view of the resin filling device 400, and FIG. 3B is a side view of the resin filling device 400. The resin filling device 400 includes a bottom portion 401, a core portion 402, an outer wall 403, a top lid 404, and a resin filling tube 405. A description of the resin filling tube 405 is omitted in FIG. 3A. The bottom portion 401 has an approximately disc-shaped bottom portion 401a and a cylindrical sidewall portion 401b. In the same way, the top lid 404 also has a bottom portion 404a and a cylindrical sidewall portion 404b. The inside diameter of the sidewall portion 401b or sidewall portion 404b is approximately the same as the outside diameter of the cylinder of the electromagnetic coils 100. The core portion 402 is cylindrically shaped. The curvature of the side surface of the core portion 402 may be the same as the curvature of the concavities of the apices of the protrusions 152 shown in FIGS. 2A to 2E. Also, the inside of the core portion 402 may be of either a hollow structure or a solid structure. The inside surface of the outer wall 403 is cylindrically shaped. In the embodiment, in order to integrally mold the electromagnetic coils 100 and coil back yoke 115, the gap between the side surface of the core portion 402 and the inside surface of the outer wall 403 is made slightly wider than the sum of the heights of the protrusions 151 and protrusions 152 of the cylindrically shaped plate 150. In a case of molding only the electromagnetic coils 100, the gap between the side surface of the core portion 402 and the inside surface of the outer wall 403 may be approximately the same as two times the height of the protrusions 151 of the cylindrically shaped plate 150. The resin filling tube 405 is connected to the top lid 404, and the position of the connection is between the side surface of the core portion 402 and the inside surface of the outer wall. The plate 150, formed in FIG. 2D and changed in shape into the cylinder, on which the coils 100A and 100B are wound is disposed in a space formed by the bottom portion 401, core portion 402, outer wall 403, and top lid 404. At this time, the coil back yoke 115 may be simultaneously disposed. The resin is injected into the space from the resin filling tube 405 while the bottom portion 401 and top lid 404 are being pressurized from below and above, thereby forming the cylindrical electromagnetic coils 100 firmed with the resin.

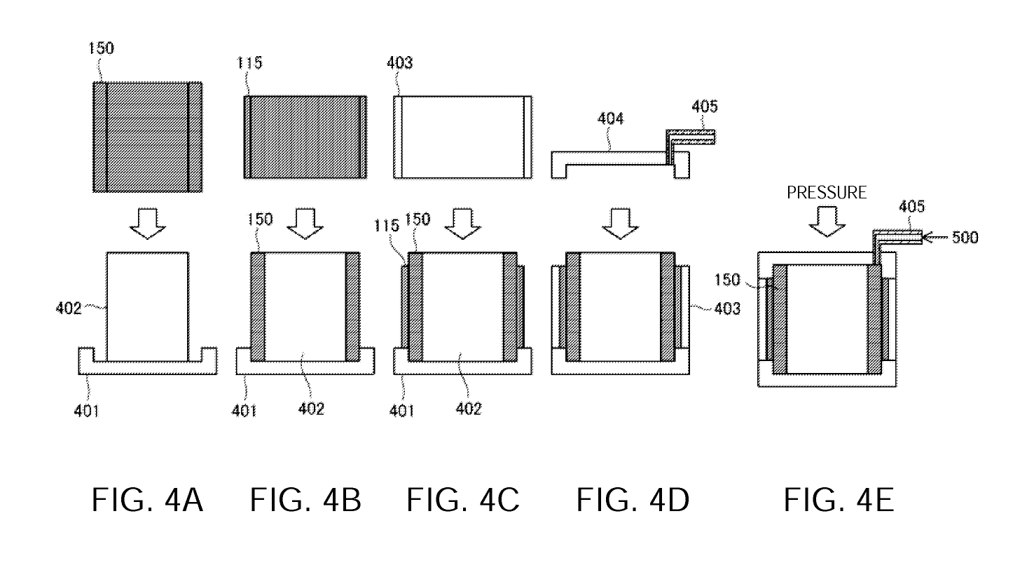

FIGS. 4A to 4E are illustrations showing steps of firming the electromagnetic coils with the resin. In the embodiment, the coil back yoke 115 is also simultaneously firmed with the resin. In the step shown in FIG. 4A, the core portion 402 is disposed on and in the center of the bottom portion 401. Next, the plate 150, formed in the step of FIG. 2D and changed in shape into the cylinder on which the electromagnetic coils 100A and 100B are wound, is disposed. At this time, the plate 150 is disposed in such a way that the core portion 402 fits inside the cylindrical plate 150. In the step shown in FIG. 4B, the coil back yoke 115 is disposed on the outer side of the cylindrical plate 150. The coil back yoke 115 is disposed in such a way as to be placed on the sidewall portion 401b of the bottom portion 401. Then, the position of the longitudinal center of the cylinder of the coil back yoke 115 and the position of the longitudinal center of the cylinder of the plate 150 are approximately the same. Consequently, it is preferable that the height of the sidewall portion 401b of the bottom portion 401 is half the difference between the length of the cylinder of the plate 150 and the length of the cylinder of the coil back yoke 115.

In the step shown in FIG. 4C, the outer wall 403 is disposed on the outer side of the coil back yoke 115 in such a way as to be placed on the sidewall portion 401b. It is preferable that the length of the outer wall 403 is approximately the same as the length of the coil back yoke 115. In the step shown in FIG. 4D, the top lid 404 is disposed. The resin filling tube 405 is connected to the top lid 404. In the step shown in FIG. 4E, the space between the top lid 404 and bottom portion 401, while being pressurized, is filled with the resin from the resin filling tube 405.

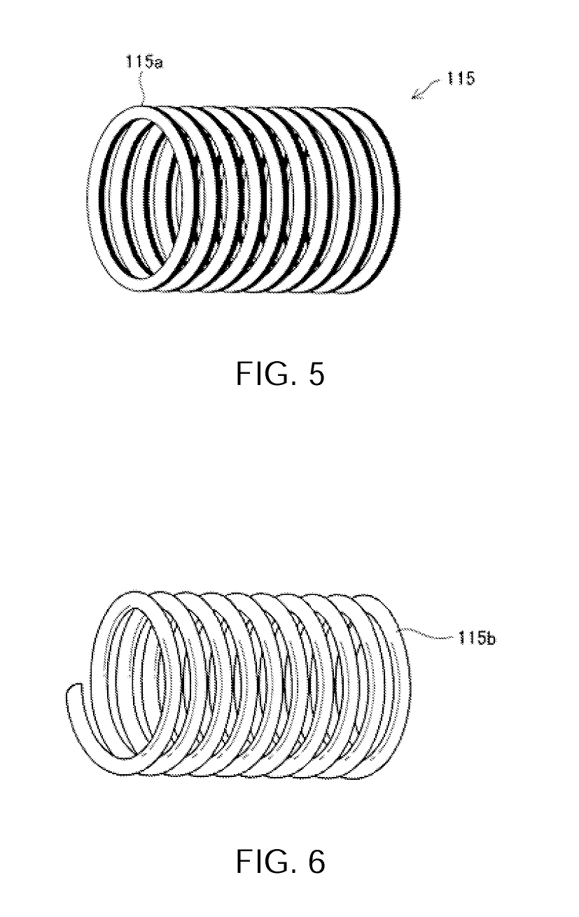

FIG. 5 is an illustration showing a configuration of the coil back yoke 115. The coil back yoke 115 includes a plurality of holed discs 115a. The holed discs 115a are stacked into a cylindrical form, forming the coil back yoke 115. Each holed disc 115a can be easily manufactured by stamping out from a flat steel plate. As the resistance between adjacent holed discs 115a is higher than when the discs are solid, or adjacent holed discs 115a are insulated from one another, the eddy-current loss is highly effectively reduced.

FIG. 6 is an illustration showing another configuration example of the coil back yoke 115. The coil back yoke 115 is formed by coiling a plate 115b having a thickness smaller than its width in a spiral form in a direction of the thickness. When the plate 115b is coiled in the spiral form, it is formed of one member, and it is not necessary to bring the holed discs 115a together into the cylindrical form, meaning that it is easy to mold and manufacture the coil back yoke 115.

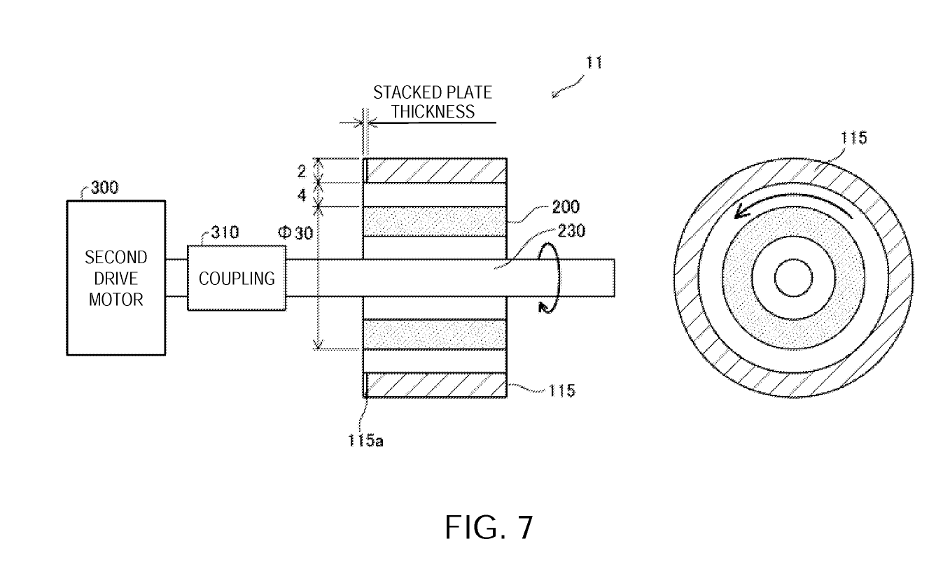

FIG. 7 is an illustration schematically showing an eddy current measurement. A measured motor 11 includes a permanent magnet 200, a rotating shaft 230, and a coil back yoke 115. The rotating shaft 230 is connected to a drive motor 300 by a coupling 310. In the embodiment, the measured motor 11 is driven by the drive motor 300, a drive voltage and current of the drive motor, and a back electromotive force voltage and back electromotive force current generated in the measured motor 11, are measured, and an eddy-current loss of the measured motor 11 is acquired using the results of the measurements. In the embodiment, as a structure of the coil back yoke 115, for example, a solid structure or a stacked structure formed by stacking a plurality of holed discs 115a with differing plate thicknesses is employed, a back electromotive force voltage and back electromotive force current are measured, and eddy-current loss characteristics are acquired using the results of the measurements.

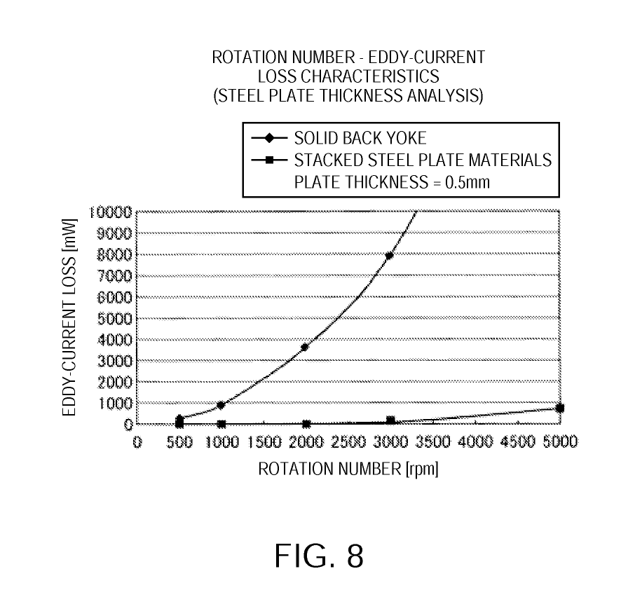

FIG. 8 is an illustration showing an eddy-current loss of the embodiment. Herein, two structures of the coil back yoke 115 are compared, one of which is the stacked structure in which the holed discs 115a are stacked, and the other of which is not the stacked structure in which the holed discs 115a are stacked, but the solid structure. The eddy-current loss is smaller when the coil back yoke 115 has the stacked structure (refer to FIG. 6) than when the coil back yoke 115 is of the solid structure.

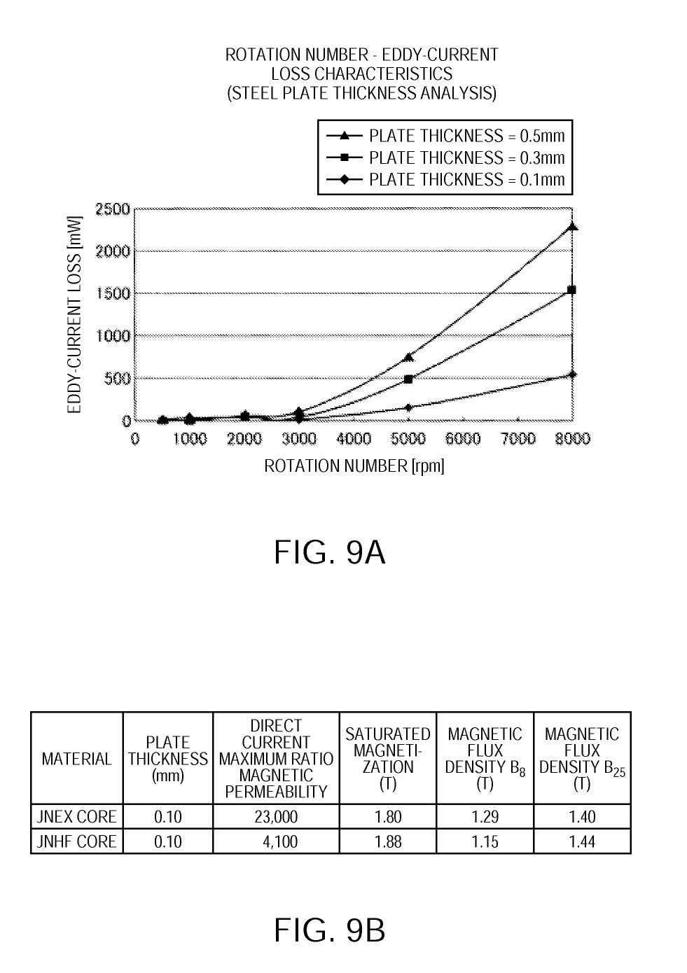

FIGS. 9A and 9B are illustrations showing a relationship between the thickness of the holed discs 115a and the eddy-current loss when the coil back yoke 115 employs the stacked structure. A smaller thickness of the holed discs 115a results in a smaller eddy-current loss. Herein, as a material for a plate thickness of 0.1 mm, JNEX-Core by JFE Steel Corporation is used. Rotation number—eddy-current loss characteristics are shown in FIG. 9A, and data of JNEX-Core are listed in FIG. 9B. Data of another material JNHF-Core by JFE Steel Corporation are also listed in FIG. 9B. JNEX-Core contains 6.5% of Si over the whole area of a steel plate material, and JNHF-Core contains 6.5% of Si in 25% of either surface area of a steel plate material, and no Si in 50% of the central portion excepting either surface area of the steel plate material. With a common silicon steel plate (a Si content of 3.5%), it is difficult to reduce the plate thickness to 0.1 mm. When an eddy current is also obtained for JNHF-Core too in the same way, although not listed in FIG. 9A, the eddy current is slightly smaller than that of JNEX-Core, and the result of the back electromotive force voltage of JNHF-Core being equivalent to or larger than that of JNEX-Core has been obtained.

It is thought that the heretofore described result arises from the following reason. The eddy current is generated in a direction perpendicular to a movement direction of magnetic fluxes of the rotating permanent magnet 200, that is, in a direction perpendicular to a plane formed by the boundary between two holed discs 115a. Consequently, it is possible to make the eddy current flowing through the coil back yoke 115 smaller when the coil back yoke 115 is formed by stacking thin holed discs 115a, that is, in the case of the stacked structure, and it is possible to reduce the eddy-current loss. Then, the larger the number of holed discs 115a stacked, that is, the thinner the holed discs 115a, the smaller it is possible to make the eddy current. An insulator may be inserted between adjacent holed discs 115a. It becomes more difficult for the eddy current to move in adjacent holed discs 115a.

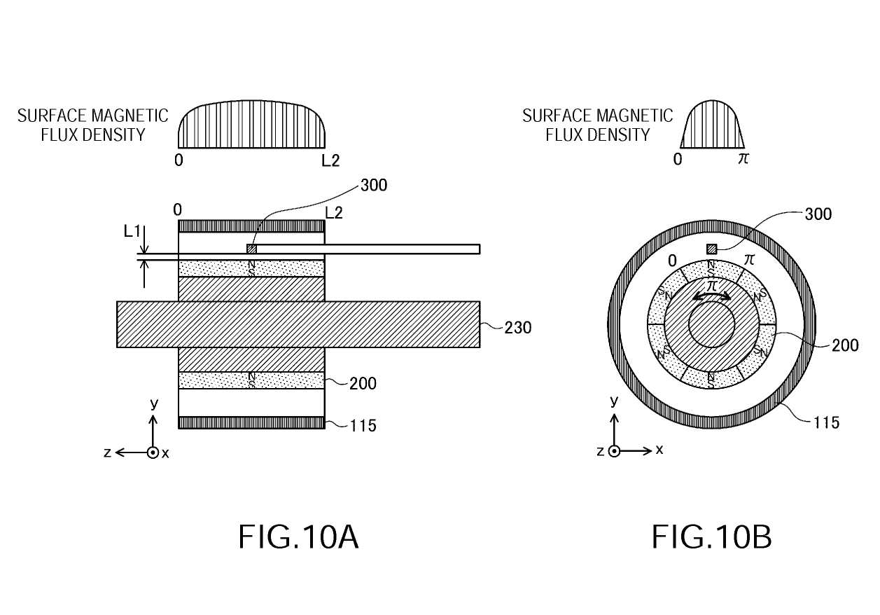

FIGS. 10A and 10B are illustrations showing a model of a magnetic field analysis. FIG. 10A is a diagram seen from a direction (an x direction) perpendicular to a direction of a rotating shaft 230, and FIG. 10B is a diagram seen from the direction (a z direction) of the rotating shaft 230. With the model, six permanent magnets 200, the rotating shaft 230, a magnetic sensor 300, and a coil back yoke 115 are included. The permanent magnets 200 are disposed around the rotating shaft 230, and a direction of magnetization is a radial direction centered on the rotating shaft 230. The coil back yoke 115, having an approximately cylindrical form, is spaced a constant distance from the permanent magnets 200. Therein, in order to measure the magnetic flux density of a space region in which an electromagnetic coil 100 is provided, a magnetic flux density corresponding to a distance (L1) from the peripheral surface of the permanent magnets 200 to midway to the coil back yoke 115 is observed with the magnetic sensor 300 configured of a Hall element.

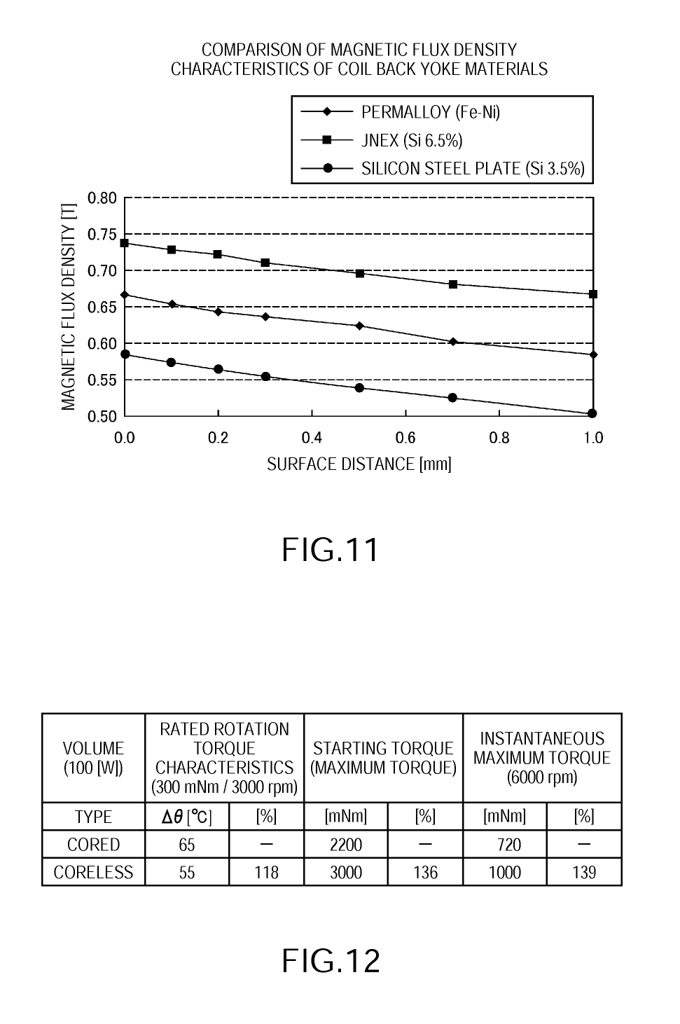

FIG. 11 is an illustration showing a result of a measurement of a relationship between the distance between the permanent magnet surface and magnet sensor and the magnetic flux density. In the embodiment, as materials of the coil back yoke 115, JFE Steel Corporation's JNEX-Core (a Si content of 6.5%), a permalloy (Fe—Ni), and a silicon steel plate (a Si content of 3.5%) are used, and compared. When JNEX-Core is used as a material of the coil back yoke 115, a higher magnetic flux density is obtained than when the permalloy is used, or when the silicon steel plate is used, as a material of the coil back yoke 115. This result is thought to be attributed to the fact that the permalloy surpasses JFE Steel Corporation's JNEX-Core in magnetic permeability, but JFE Steel Corporation's JNEX-Core surpasses the permalloy in saturation magnetic flux density. Also, JNEX-Core, being a high silicon steel plate the whole of whose interior portion has a uniform 6.5 silicon composition, is higher in silicon content as compared with a heretofore known silicon steel plate. Considering the silicon content with respect to the magnetic flux density measurement result, it is thought that the higher the silicon content, the higher it is possible to make the magnetic flux density. To give consideration based on the Si content of the silicon steel plate and JNEX-Core, it is estimated to be sufficient that the Si content is 5% or more in order to exceed the magnetic flux density of the permalloy.

With an actual motor 10, the electromagnetic coil 100 is disposed in the space of measurement of the magnetic flux density measured in the embodiment, and a rotational movement is generated by “Fleming's left-hand rule” with the permanent magnet 200 and electromagnetic coil 100. Consequently, by changing the material of the coil back yoke 115 from the permalloy to JFE Steel Corporation's JNEX-Core or JNHF-Core, it is possible to improve the magnetic flux density, and it is possible to improve the performance (torque and efficiency) of the motor 10. Also, with JFE Steel Corporation's JNEX-Core or JNHF-Core, the material can be formed to a very small thickness of 0.1 mm. For this reason, as heretofore described, it is possible to make the eddy-current loss generated by the rotation of the permanent magnet 200 of the motor 100 very small.

FIG. 12 is an illustration comparing the characteristics of the coreless motor according to the embodiment and those of a cored motor which is a comparison example of the same volume. In motor rated rotation torque characteristics (rotation number 3000 rpm and torque 300 mNm), the rise in temperature of the comparison example is 65° C., while the rise in temperature of the coreless motor of the embodiment is 55° C., and the rise in temperature, that is, the heat generation, is smaller in the embodiment. This is because the heat generation becomes smaller owing to the result from the fact that, as magnetic fluxes of the magnets 200 on the rotor side concentrate by means of the coil back yoke 115, according to the embodiment, the magnetic flux density into the active coil region increases, meaning that the current flowing through the electromagnetic coils 100 decreases, and a copper loss from the electromagnetic coils 100 decreases, and owing to a coil back yoke structure which prevents the eddy-current loss from occurring in the coil back yoke 115 due to a rotating magnetic field of the magnets 200 on the rotor side. Furthermore, as the effect of the coreless motor owing to the coil back yoke 115 is such that a starting torque is 136%, and an instantaneous maximum torque (a torque when a constant rotation is controlled to 6000 rpm, a load torque is increased for three seconds, and 6000 rpm cannot be maintained any further) is 139%, the result of the effect of the coreless motor considerably exceeding that of the cored motor can be obtained. With a heretofore known coreless motor (including no coil back yoke), in the comparison with the same volume, the actual condition is that only a torque of around 40% or less is obtained in comparison with the cored motor. However, with the result of the embodiment, a characteristic effect higher than that of the cored motor can be obtained. This has a very important meaning for reshaping the common conception of coreless motor characteristics for the motor field, and eliminating an iron loss (hysteresis loss, eddy-current loss).

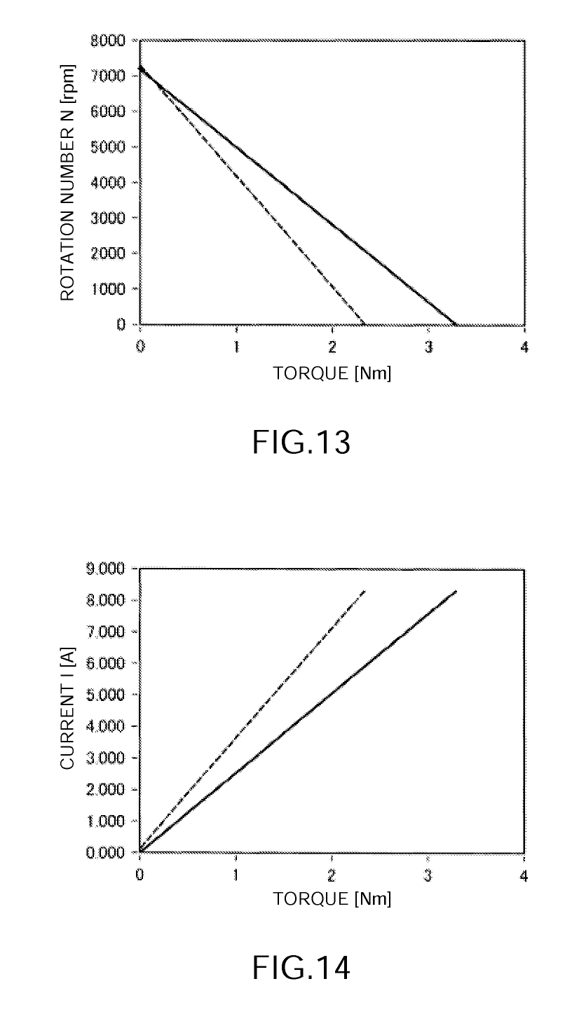

FIG. 13 is an illustration comparing a relationship in torque and rotation number between the coreless motor of the embodiment and the cored motor of the comparison example with the same volume. Herein, the solid line is the embodiment, and the broken line is the comparison example (hereafter the same in FIGS. 14 to 17). The no-load rotation numbers of the embodiment and comparison example are approximately the same, but a larger starting torque can be obtained. FIG. 14 is an illustration comparing a relationship in torque and current between the coreless motor of the embodiment and the cored motor of the comparison example. With the embodiment, a smaller current than with the comparison example is sufficient, provided that the torque is the same, and a larger torque than with the comparison example can be obtained, provided that the current is the same.

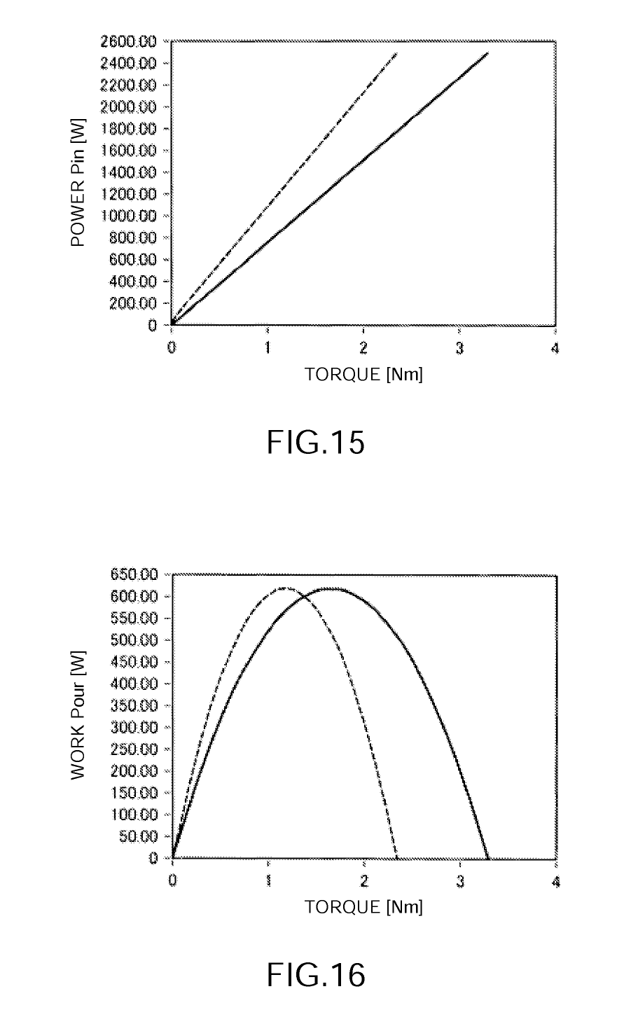

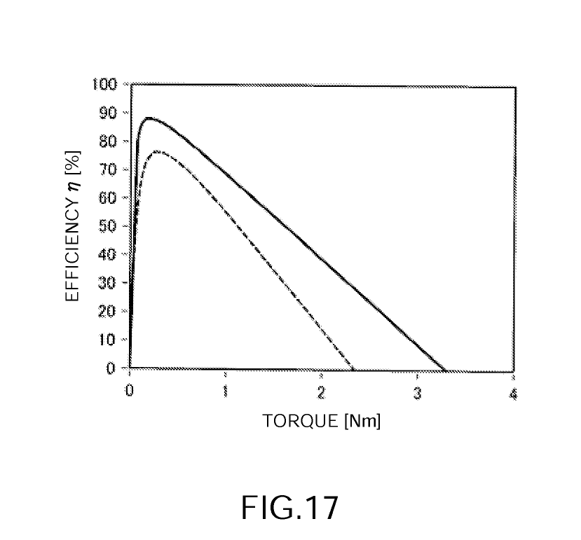

FIG. 15 is an illustration comparing a relationship in torque and input power between the coreless motor of the embodiment and the cored motor of the comparison example with the same volume. With the embodiment, less input power than with the comparison example is sufficient when attempting to obtain the same torque, and a larger torque can be obtained, provided that the input power is the same. FIG. 16 is an illustration comparing a relationship in torque and output power (work) between the coreless motor of the embodiment and the cored motor of the comparison example. FIG. 17 is an illustration comparing a relationship in torque and efficiency (=output power/input power) between the coreless motor of the embodiment and the cored motor of the comparison example with the same volume. The motor of the embodiment is more efficient than that of the comparison example, provided that the torque is the same. From the above, it can be said that, with the motor (coreless motor) of the embodiment, it is possible to drive at a higher torque than that of the cored motor of the comparison example, and it is possible to realize a higher performance.

As above, according to the first embodiment, by disposing the coil back yoke 115 in the portion coinciding with the active coil region, and furthermore, providing a cylindrical member 114 of the coil back yoke 115 with the stacked structure, it is possible to reduce the eddy-current loss occurring in the coil back yoke 115. Then, as the eddy-current loss is a loss, by reducing it, it is possible to realize a high torque. The eddy current generated in the coil back yoke 115 is of a direction perpendicular to the rotation direction of the rotor 20. Consequently, it is preferable that the holed discs 115a configuring the coil back yoke 115 include a layered structure parallel to the rotation direction of the rotor 20. By employing the structure, it is possible to make it difficult for the eddy current to flow, and as a result, it is possible to make it difficult for the eddy-current loss to occur.

In the embodiment, the coil back yoke 115 covers the active coil region, but does not cover the coil ends. For this reason, it is difficult to have the effect of a magnetic flux change due to a change of current flowing through the coil ends, and it is possible to curb a generation of eddy current due to the magnetic flux change. Also, by disposing the permanent magnets 200 in such a way as to cause the projection region of the magnetic fluxes of the permanent magnets 200 to coincide with the active coil region, it is also possible to curb the eddy current generated at the coil ends by a magnetic flux change due to the rotation of the permanent magnets 200.

### Second Embodiment

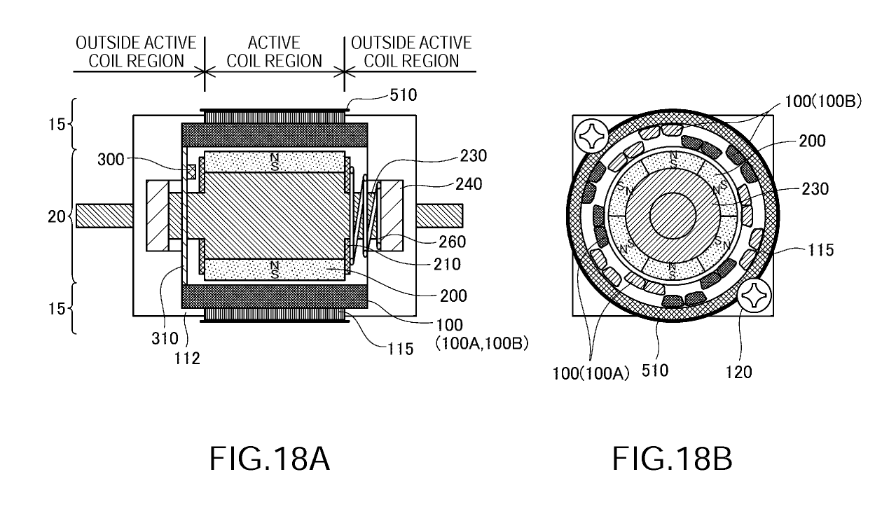

FIGS. 18A and 18B are illustrations showing a coreless motor of a second embodiment. FIG. 18A is a section of the coreless motor 10 taken on a plane parallel to its rotating shaft, and FIG. 18B is a section of the coreless motor taken on a plane perpendicular to its rotating shaft. The coreless motor 10 is an inner rotor type motor of which an approximately cylindrical stator 15 is disposed on the outer side, and an approximately cylindrical rotor 20 is disposed on the inner side. The stator 15 has a plurality of electromagnetic coils 100A and 100B arranged along the inner periphery of a casing 110. A description will be given using diagrams simulated in principle, taking the electromagnetic coils 100A and 100B to be two-phase, and omitting an actual disposition including the coil ends. The electromagnetic coils 100A and 100B in combination are also called the electromagnetic coils 100. The stator 15 further has magnetic sensors 300 as position sensors, which detect the phase of the rotor 20, disposed one for each of the phases of the electromagnetic coils 100 (FIG. 18A). The magnetic sensors 300 are fixed to a circuit substrate 310, and the circuit substrate 310 is fixed to the casing 110. The casing 110 is formed from a resin. The casing 110 may have a structure in which it is covered with a resin containing a soft magnetic powder material as a coil back yoke made of a soft magnetic material. Also, a coil back yoke made of a soft magnetic material may be provided between the casing 110 and electromagnetic coils 100.

The rotor 20 has six permanent magnets 200 on its periphery, and the rotating shaft 230 is provided in the center of the rotor 20. The rotating shaft 230 is supported by bearings 240 of the casing 110. Each permanent magnet 200 is magnetized in a radial direction toward the exterior from the center of the rotating shaft 230. In this example, a coil spring 260 is provided on an inner side of the casing 110, and the positioning of the permanent magnets 200 is carried out by the coil spring 260 pressing the permanent magnets 200 in the left direction of the drawing. However, the coil spring 260 can be omitted.

The second embodiment differs in comparison with the first embodiment in that the casing 110 does not have the cylindrically shaped portion 111. Then, with the second embodiment, a coil back yoke 115 protrudes outside the casing 110. The configuration of the coil back yoke 115 is the same as that of the first embodiment. A thermal conductive resin 510 is formed on the outer side of the protruding coil back yoke 115. With the configuration of the second embodiment too, it is possible to reduce an eddy current generated in the coil back yoke 115, and improve the efficiency of the coreless motor. Also, with the second embodiment, as the coil back yoke 115 protrudes outside the casing 110, even when a heat generation due to an eddy-current loss occurs, the heat is easily released. Also, with the embodiment, as the thermal conductive resin 510 which also has a non-conductivity (a withstand voltage=1.2 kV or more) owing to an electrodeposition coating (a film thickness of 20 μm or less) or the like is provided on the outer side of the coil back yoke 115, an arrangement is such that the heat generated by the eddy-current loss is easily released via the thermal conductive resin 510.

### Third Embodiment

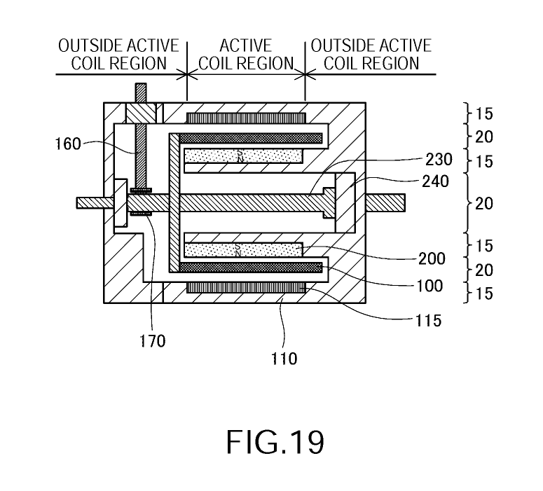

FIG. 19 is an illustration showing a third embodiment. The third embodiment is a coreless brush motor. In the first and second embodiments, the electromagnetic coils 100 are provided on the stator 15, and the permanent magnets 200 are provided on the rotor 20. As opposed to this, in the third embodiment, an electromagnetic coil 100 is provided on a rotor 20, and permanent magnets 200 are provided on a stator 15. That is, in the first and second embodiments, the permanent magnets rotate but, in the third embodiment, the electromagnetic coil 100 rotates. In the third embodiment, the motor includes a commuter 170 for changing the orientation of current flowing though the rotating electromagnetic coil 100, and a brush 160 in contact with the commuter 170. A coil back yoke 115 is provided on a side of the electromagnetic coil 100 opposite to the permanent magnets 200.

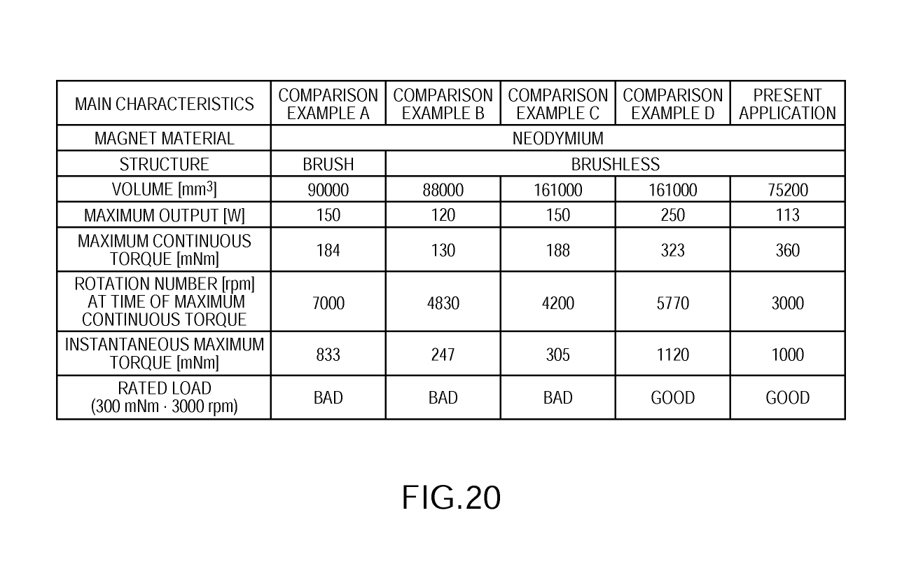

FIG. 20 is an illustration comparing the torque characteristics of the coreless motor of the embodiment and those of coreless motors of comparison examples. In the embodiment as well as in comparison examples A to D, neodymium is used as a magnet material of the permanent magnets 200. It is only possible to realize a maximum continuous torque of over 300 mNm in the comparison example D or the embodiment. Also, when realizing the maximum continuous torque of over 300 mNm, in the comparison example D, a large output of 250 W is required with respect to a maximum continuous torque of 323 mNm, while in the embodiment, an output of 113 W is sufficient with respect to a larger maximum continuous torque of 360 mNm. With the embodiment, it is possible to realize a higher torque with less output, that is, less power consumption. Also, the motor of the embodiment is of as small a size as those of the comparison examples A and C. In general, with a small motor, it is difficult to realize a high torque. However, with the embodiment, in spite of the small size, it is possible to realize a high torque. That is, according to the embodiment, in spite of the small size and low power consumption, it is possible to realize a high torque motor. As can be seen from FIG. 20 too, maximum continuous torque characteristics in a coreless motor are determined from a heat generation (a consumption current=a copper loss) and casing size (volume) of the motor. From the fact that the value of the casing size (volume) is small, and the value of the maximum continuous torque is large, it can be said how small the consumption current (copper loss) of the coreless motor of the present application is.

### Fourth Embodiment

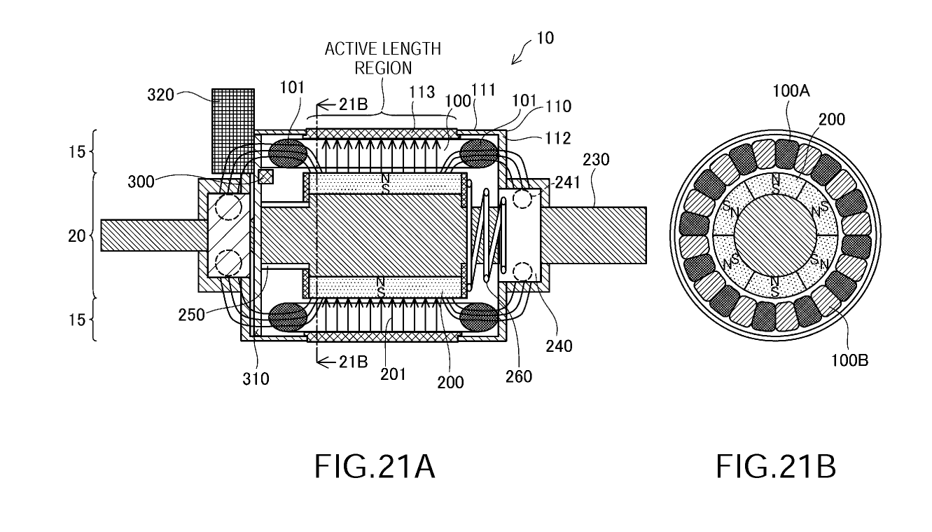

FIGS. 21A and 21B are illustrations schematically showing a configuration of a coreless motor of a fourth embodiment. FIG. 21A is a section of the coreless motor 10 taken on a plane parallel to its rotating shaft, and FIG. 21B is a section of the coreless motor taken on the plane (cutting plane 21B-21B) perpendicular to its rotating shaft.

The coreless motor 10 is an inner rotor type motor of a radial gap structure in which an approximately cylindrical stator 15 is disposed on the outer side, and an approximately cylindrical rotor 20 is disposed on the inner side. The stator 15 has a plurality of electromagnetic coils 100A and 100B arranged along the inner periphery of a casing 110. The electromagnetic coils 100A and 100B are coreless (air-cored). The electromagnetic coils 100A and 100B in combination are also called the electromagnetic coils 100. The stator 15 further has magnetic sensors 300 as position sensors, which detect the phase of the rotor 20, disposed one for each of the phases of the electromagnetic coils 100 (FIG. 21A). The magnetic sensors 300 are fixed to the circuit substrate 310, and the circuit substrate 310 is fixed to a casing 110.

The rotor 20 has the rotating shaft 230 in the center, and has six permanent magnets 200 on the periphery. Each permanent magnet 200 is magnetized in a radial direction toward the exterior from the center of the rotating shaft 230. Also, the permanent magnets 200 and electromagnetic coils 100 are disposed, opposed to each other, on the opposed cylindrical surfaces of the rotor 20 and stator 15.

The rotating shaft 230 is supported by bearings 240 of the casing 110, and the bearings 240 include ball bearings 241. In the embodiment, the motor includes a coil spring 260 on an inner side of the casing 110. The coil spring 260, by pressing the permanent magnets 200 in the left direction of the drawing, carries out the positioning of the permanent magnets 200. However, the coil spring 260 can be omitted.

The casing 110 is configured of a cylindrically shaped portion (a side surface portion) 111 parallel to the rotating shaft 230, and disc-shaped portions (end face portions) 112, perpendicular to the rotating shaft 230, disposed at either end of the cylindrically shaped portion 111. The cylindrically shaped portion 111 and disc-shaped portions 112 are formed from a resin. A central portion 113 of the cylindrically shaped portion 111 is formed of a magnetic member. The central portion 113 is a region onto which the casing 110 is projected when the permanent magnets 200 are projected in a direction toward the electromagnetic coils 100 from the permanent magnets 200. The central portion 113 is also called an “active length region 113”. Also, the central portion 113, as it has a cylindrical form, is also called a “cylindrical member 113”. It is also acceptable that the active length region 113 is configured of a magnetic member, and caused to function as a coil back yoke, concentrating magnetic fluxes 201 on the active length region 113. In this case, it is easy for the magnet fluxes 201 to pass through only the active coil region of the electromagnetic coils 100, and it is possible to improve the efficiency of the coreless motor 10. The active length region 113 approximately coincides with the active coil region shown in the first embodiment.

Also, the active length region 113 is exposed to the exterior of the coreless motor 10. Then, the active length region 113, as well as being of a magnetic member, may also be of a conductive member. As the active length region 113 functions as a coil back yoke, the magnet fluxes 201 from the permanent magnets 200 pass through the inner side of the electromagnetic coils 100, and easily pass through the active length region 113. Herein, on the rotor 20 rotating, the permanent magnets 200 also rotate. Because of this, the magnet fluxes passing through the active length 113 change, and a current generating magnet fluxes in a direction in which the change of the magnet fluxes is impeded, that is, an eddy current, is generated. On the eddy current flowing, a power loss (an eddy-current loss) occurs, and is released as heat. With the embodiment, as the active length region 113 is exposed to the exterior of the coreless motor 10, it is possible, even when heat is generated by the eddy-current loss, to easily discharge the heat to the exterior of the coreless motor 10, and prevent the heat from being retained inside the coreless motor 10. As a material configuring the active length region 113, the active length region 113 may be covered with a material, such as an aluminum material, which has a high thermal conductivity and a heat dissipation effect. By so doing, it is possible to further increase the heat dissipation effect, and make the torque higher. The active length region 113 may have a structure in which holed discs are stacked (refer to FIG. 5), or a structure in which a long and thin plate is spirally coiled (refer to FIG. 6), in the same way as with the coil back yoke 115 of the first embodiment. With metallic glass, which is attracting attention as a magnetic material with a high magnetic permeability, it is possible to further reduce the eddy-current loss as the metallic glass can be molded to a small thickness of 0.025 mm.

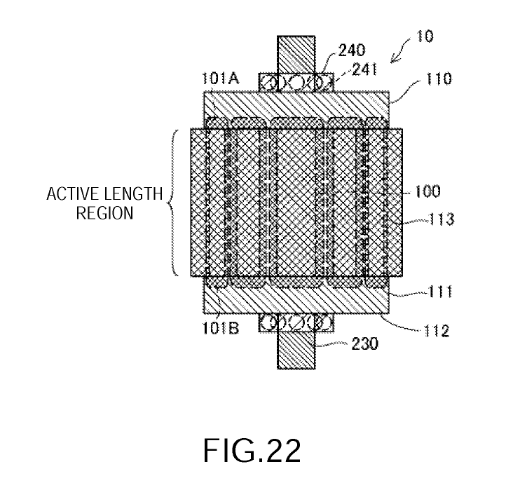

FIG. 22 is an illustration schematically showing a relationship in position between the central portion and electromagnetic coils. The central portion 113 (active length region 113) coincides with a region between two coil ends 101A and 101B of the disc-shaped portion 112. In the description in FIG. 21A, the range of the active length region 113 is set as the region onto which the permanent magnets 200 are projected in the radial direction, but it may be set by the relationship between the two coil ends 101A and 101B in this way. Also, the active length region 113 may be made the region onto which the permanent magnets 200 are projected in the radial direction.

In the embodiment, the active length region 113 is made the region coinciding with the region between the two coil ends 101A and 101B in the relationship between the two coil ends 101A and 101B, but the active length region 113 may have portions overlapping the two coil ends 101A and 101B.

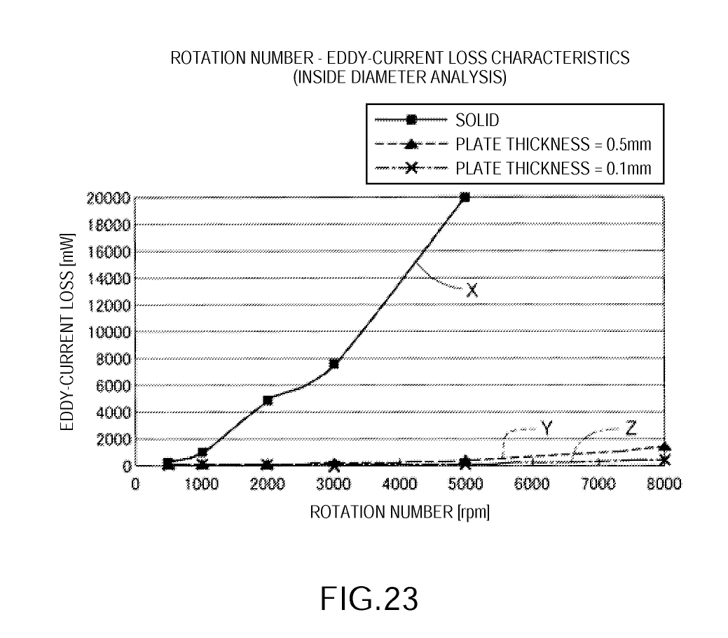

FIG. 23 is a graph showing a relationship between the rotation number and eddy-current loss of the motor. The measurement of the eddy-current loss is performed using the method shown in FIG. 7. The coil back yoke 115 is used in FIG. 7, but the result of FIG. 23 is a result when the cylindrical member 113 is used in place of the coil back yoke 115 of FIG. 7. Herein, a line X shows a characteristic when the cylindrical member 113 is of a solid structure having no stacked structure. Lines Y and Z show characteristics when the cylindrical member 113 has a stacked structure in which a large number of holed discs are stacked. Herein, the line Y shows a case in which the thickness of the holed discs (refer to FIG. 5) is 0.5 mm, and the line Z shows a case in which the thickness of the holed discs is 0.1 mm. The eddy-current loss is smaller when the cylindrical member 113 has a stacked structure than when the cylindrical member 113 has a solid structure. Then, the eddy-current loss is smaller when the thickness of the holed discs is smaller. The reason for this is the same as the reason for the coil back yoke 115 in the first embodiment.

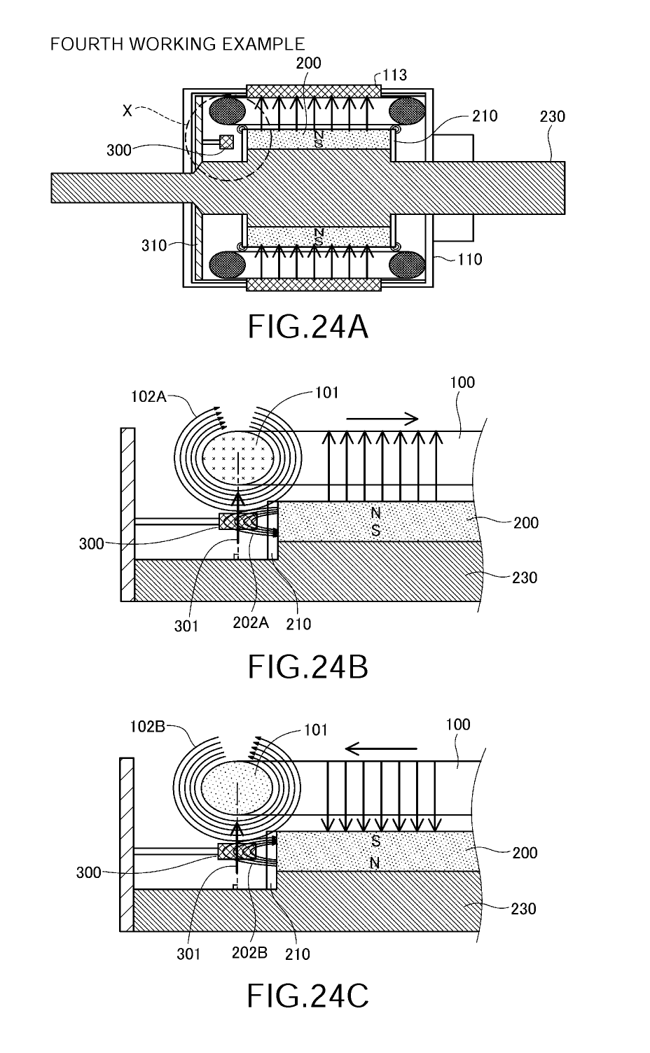

FIG. 24A to 24C are illustrations showing magnetic fluxes of the permanent magnets and electromagnetic coils in the fourth embodiment. FIGS. 24B and 24C are enlarged illustrations of an X portion of FIG. 24A. The coil spring 260 is omitted in FIG. 24A. In FIGS. 24B and 24C, the orientation of the current flowing through the electromagnetic coils 100 differs from the orientation of the magnetism of the permanent magnet 200. In the fourth embodiment, the magnetic sensor 300 is disposed on a perpendicular line extended down to the rotating shaft 230 side from the coil end 101 of the electromagnetic coils 100. A magnetic member 210 is provided between the permanent magnet 200 and magnetic sensor 300. The magnetic member 210 may be configured of, for example, a soft magnetic material. As the magnetic member 210 allows the magnetic fluxes to pass through easily, provided that the number of magnetic fluxes emitted from the permanent magnet 200 is the same, the number of magnetic fluxes 202A and 202B protruding outside the magnetic member 210 decreases by the number of magnetic fluxes passing through the magnetic member 210. As a result of this, even in the event that the magnetic sensor 300 is disposed adjacent to the permanent magnet 200, it is difficult for the output of the magnetic sensor 300 to be saturated.

A magnetic detection direction 301 of the magnetic sensor 300 is a direction parallel to the radial direction toward the outside from the center of the rotating shaft 230. Also, the detection direction 301 is a direction perpendicular to magnetic flux lines 102A and 102B generated by the current flowing through the coil end 101. Consequently, even in the event that the size of the current flowing through the electromagnetic coils 100 changes, and the number of magnetic flux lines 102A and 102B changes, no change occurs in the output of the magnetic sensor 300.

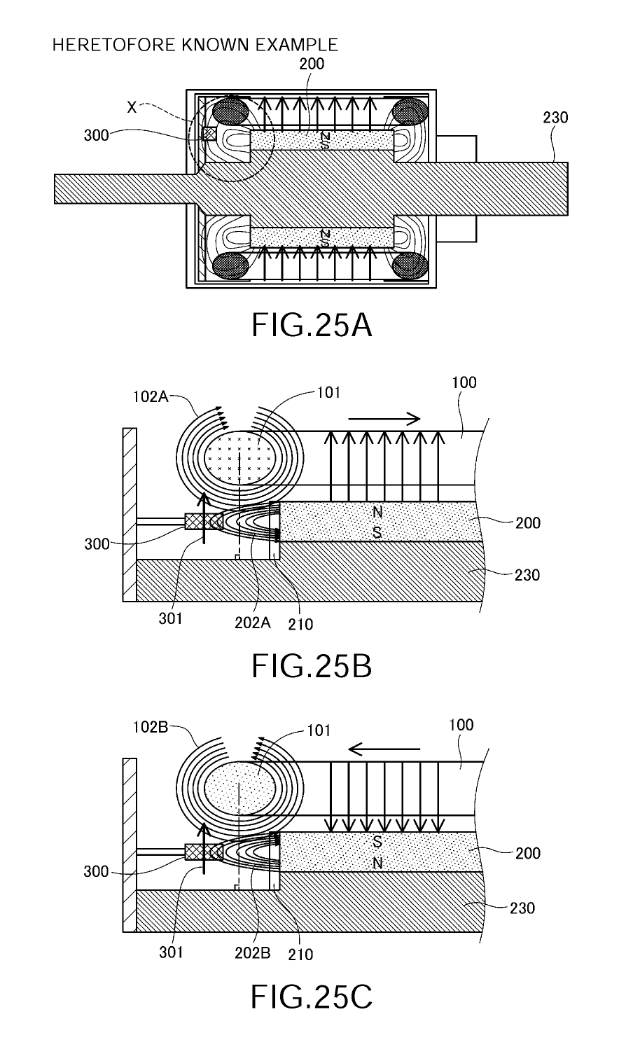

FIGS. 25A to 25C are illustrations showing magnetic fluxes of the permanent magnets and electromagnetic coils in a comparison example. In the comparison example, no magnetic member 210 is provided between the permanent magnet 200 and magnetic sensor 300. For this reason, the magnetic field of the permanent magnet 200 spreads farther than the magnetic field shown in FIGS. 24A to 24C. The magnetic sensor 300 is disposed in a position slightly distant from the permanent magnet 200 in order not to cause the output to be saturated. The position is away from a perpendicular line, extended down to the rotating shaft 230 side from the coil end 101, toward the left of the drawing. In the position, the direction of the magnetic fluxes generated by the current flowing through the coil end 101 is not perpendicular to the magnetic flux detection direction 301 of the magnetic sensor 300. For this reason, when the current flowing through the coil end 101 changes, and the number of magnetic flux lines 102A and 102B changes, there is a danger of the output of the magnetic sensor 300 being affected by the change and distorted.

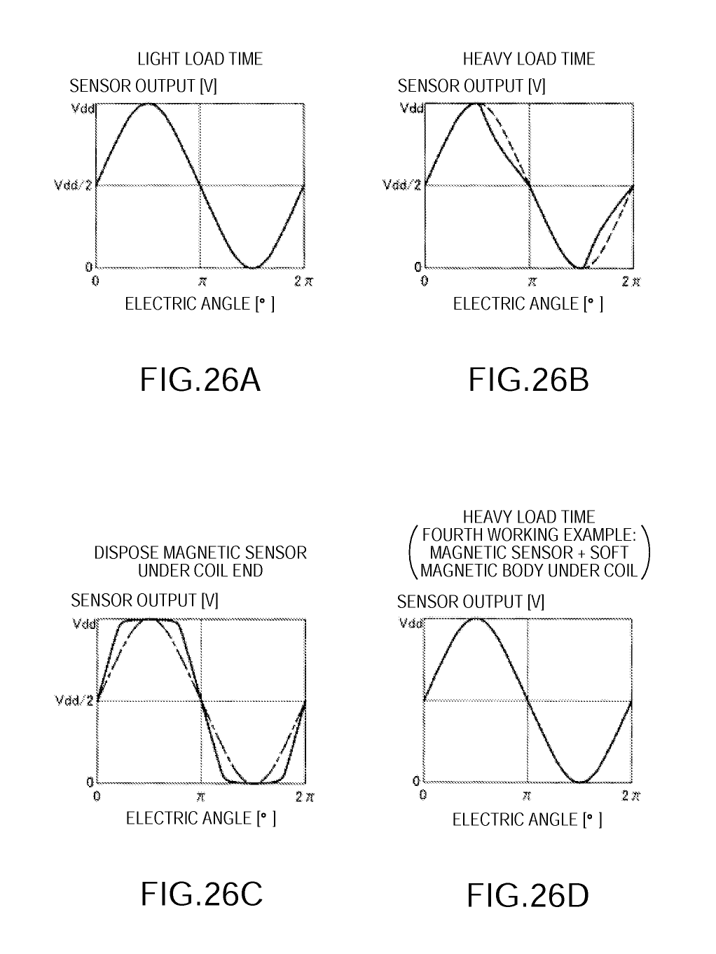

FIGS. 26A to 26D are illustrations showing outputs of the magnetic sensor. FIG. 26A shows an output of the magnetic sensor 300 at a light load time (a low current time). In this condition, no distortion occurs in the output. FIG. 26B shows an output of the magnetic sensor 300 at a heavy load time (a high current time). In this condition, a distortion occurs in the output of the magnetic sensor 300. FIG. 26C shows an output of the magnetic sensor 300 when the position of the magnetic sensor 300 in FIGS. 25A to 25C is placed on the perpendicular line extended down to the rotating shaft 230 side from the coil end 101 of the magnetic coils 100. No magnetic member 210 is disposed. In this condition, the output of the magnetic sensor 300 is saturated. FIG. 26D shows an output of the magnetic sensor 300 in the embodiment shown in FIGS. 24A to 24C. In this embodiment, as the magnetic member is provided between the magnetic sensor 300 and permanent magnet 200, the output of the magnetic sensor 300 is not saturated even at the heavy load time. Also, as the magnetic sensor 300 is provided in a position immediately below the coil end 101, a normal waveform in which the output of the magnetic sensor 300 is never distorted is exhibited. It is preferable to set the thickness of the magnetic member 210 at such a thickness as to exhibit the normal waveform in which the output of the magnetic sensor 300 is never distorted when the magnetic sensor 300 is disposed in the position immediately below the coil end 101. This thickness depends on the strength of the magnetic field of the permanent magnet 200.

Also, it is preferable that the magnetic member 210 is provided on a movement direction side surface of the permanent magnets 200 in such a way that, when the permanent magnets 200 move relative to the electromagnetic coils 100, the output waveform of the magnetic sensor 300 becomes a waveform equivalent to a waveform (a sinusoidal wave with an amplitude of 0 to +V) wherein a back electromotive force waveform (a sinusoidal wave with an amplitude of −V to +V) generated in the magnetic coils 100 is normalized, that the magnetic sensor 300 detects magnetic fluxes of the permanent magnets 200 leaking from the magnetic member 210, and that the electromagnetic coils 100 are PWM driven in accordance with the output waveform of the magnetic sensor 300. With the PWM drive, there is a high efficiency when the electromagnetic coils are driven with a waveform equivalent to the back electromotive force waveform. According to the embodiment, as the output waveform of the magnetic sensor 300 becomes the waveform equivalent to the waveform (sinusoidal wave with the amplitude of 0 to +V) wherein the back electromotive force waveform (sinusoidal wave with the amplitude of −V to +V) generated in the magnetic coils 100 is normalized, it is possible to efficiently drive the coreless motor.

As above, in the case of the comparison example, there is a problem in that the output is saturated when the magnetic sensor 300 is disposed immediately below the coil end 101 in order not to cause the output of the magnetic sensor 300 to be distorted, while the output is distorted when the magnetic sensor 300 is disposed in a position distant from the permanent magnet 200 in order not to cause the output to be saturated. However, by disposing the magnetic sensor 300 in the position in which the direction of the magnetic fluxes generated by the electromagnetic coils 100 and the direction of the magnetic fluxes detected by the magnetic sensor 300 are perpendicular to each other, and disposing a magnetic material between the magnetic sensor 300 and permanent magnet 200, as in the embodiment, it is possible to cause no distortion to occur in the output of the magnetic sensor 300, and curb an occurrence of saturation too.

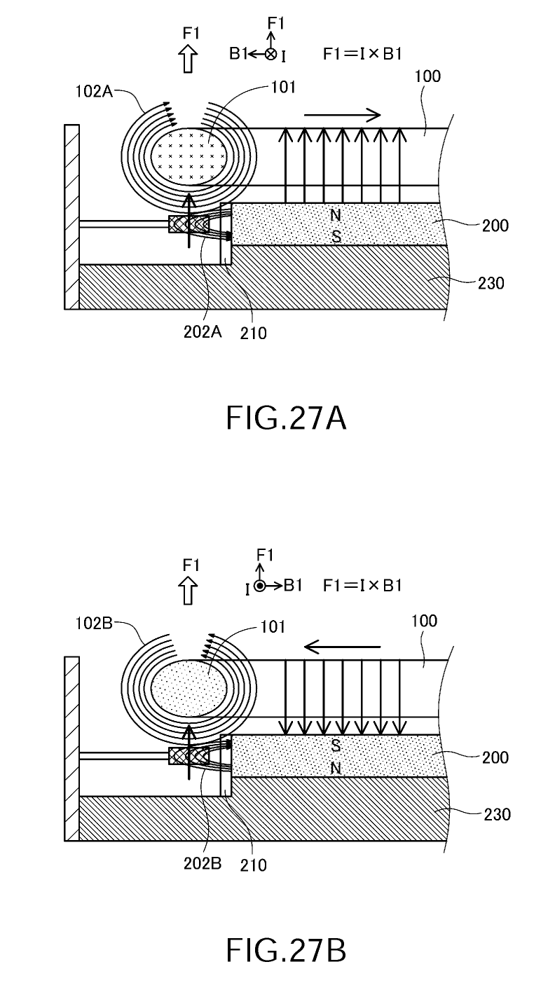

FIGS. 27A and 27B are illustrations showing a Lorentz force applied to the coil end in the fourth embodiment. FIG. 27A shows a case in which the north pole of the permanent magnet 200 is on the side of the electromagnetic coils 100, and FIG. 27B shows a case in which the south pole of the permanent magnet 200 is on the side of the electromagnetic coils 100. In FIGS. 27A and 27B, the orientations of the current flowing through the electromagnetic coils 100 are also opposite. The size of the Lorentz force to which the coil end 101 is subjected from the permanent magnet 200 is indicated by F1=I×B1. Herein, I is the size of the current flowing through the coil end 101, and B1 is the magnetic flux density of the permanent magnet 200 at the coil end 101. The mounting condition of the magnetic sensor 300 is a condition in which the magnetic sensor 300 is apart from the circuit substrate and floating, but it is preferable that the magnetic sensor 300, as it is affected by the force F1 of the coil end 101, is fixed with a resin, a molding material, or the like.

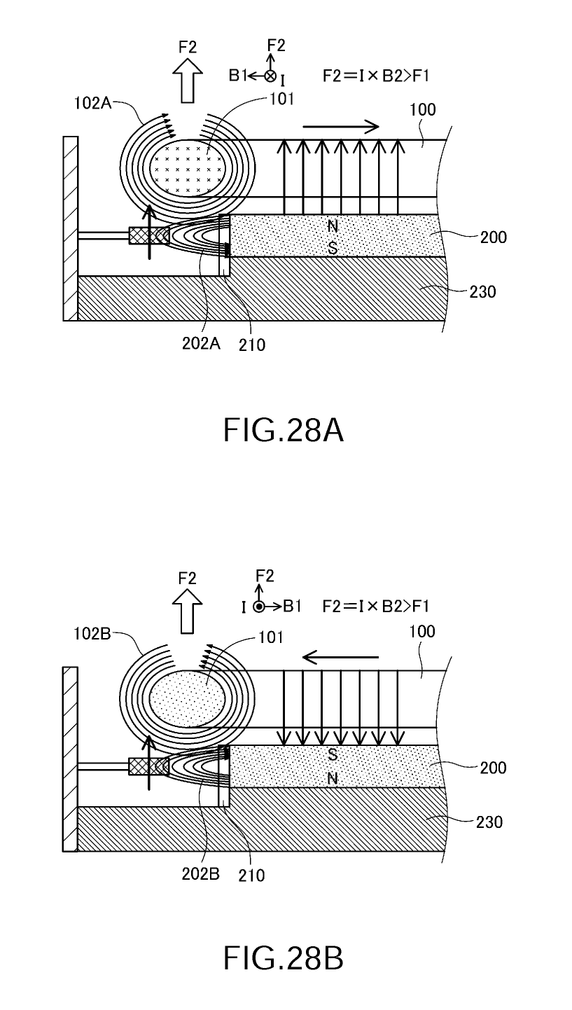

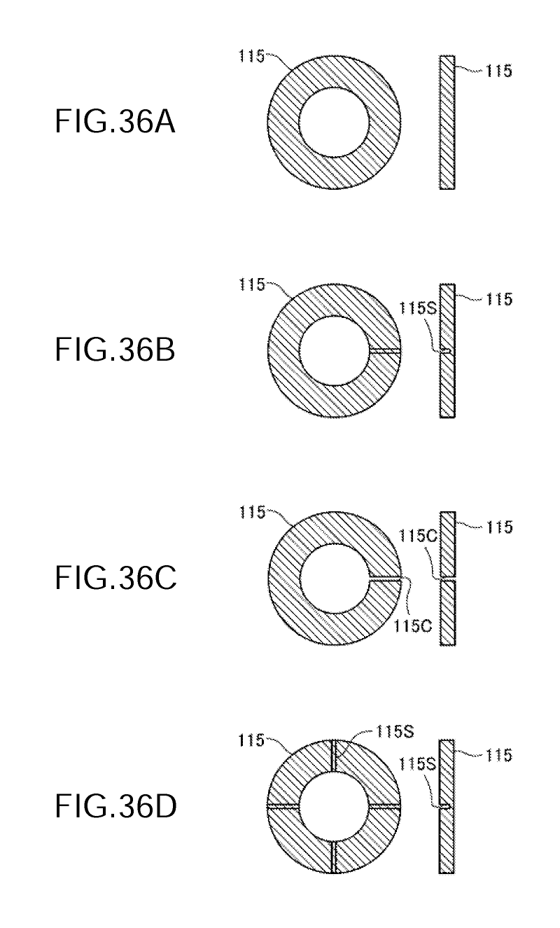

FIGS. 28A and 28B are illustrations showing a Lorentz force applied to the coil end in a comparison example. FIG. 28A shows a case in which the north pole of the permanent magnet 200 is on the side of the electromagnetic coils 100, and FIG. 28B shows a case in which the south pole of the permanent magnet 200 is on the side of the electromagnetic coils 100. In the same way, the size of the Lorentz force to which the coil end 101 is subjected from the permanent magnet 200 is indicated by F2=I×B2. Herein, in a heretofore known example, as there is no magnetic member 210, the magnetic flux density B2 at the coil end 101 is higher than in the case shown in FIGS. 36A to 36D. Consequently, F1<F2, and the Lorentz force applied to the coil end 101 is smaller in the fourth embodiment in which the magnetic member 210 is included.

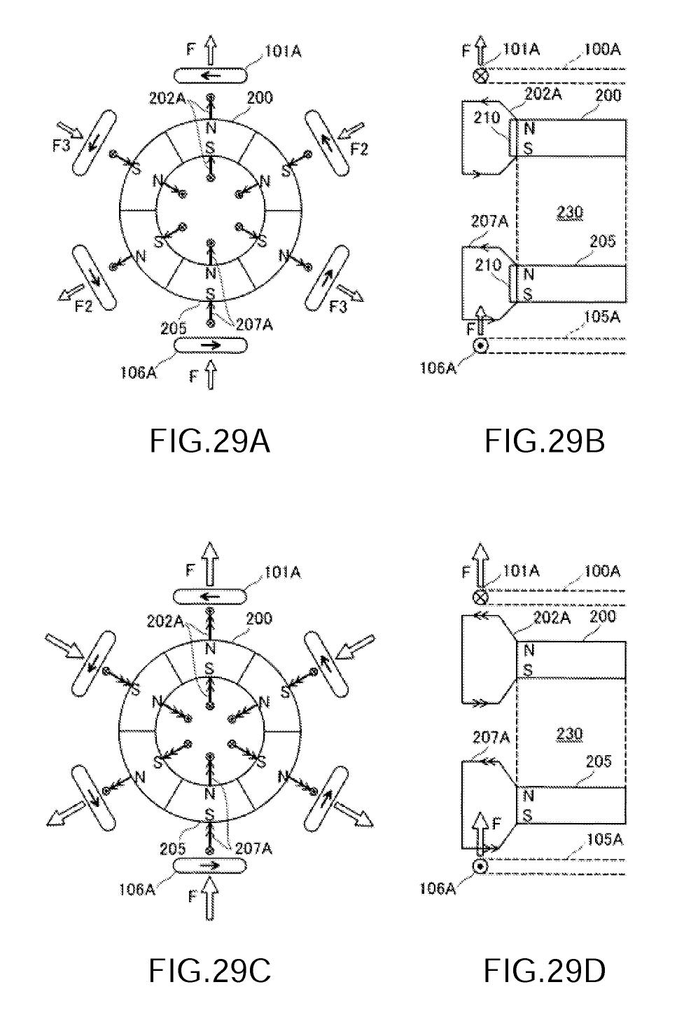

FIGS. 29A to 29D are illustrations illustrating the orientations of Lorentz forces applied to the coil ends of opposed coils. FIG. 29A is an illustration when the fourth embodiment is seen from a coil end side, and FIG. 29B is an illustration when the fourth embodiment is seen from the right side of FIG. 29A. As the orientation of a magnetic flux line 202A of a permanent magnet 200 in the upper portion of FIG. 29B is toward the left direction, and the orientation of a current flowing through a coil end 101A is from the near side to the back, the Lorentz force applied to the coil end 101A is of a direction outward from the center of the rotating shaft 230. Meanwhile, as the orientation of a magnetic flux line 207A of a permanent magnet 205 in the lower portion of FIG. 29B is toward the right direction, and the orientation of a current flowing through a coil end 106A is from the near side to the back, the Lorentz force applied to the coil end 106A is of a direction toward the center of the rotating shaft 230 from outside. As the coil ends 101A and 106A are opposed, the Lorentz force applied to the coil end 101A and the Lorentz force applied to the coil end 106A are of the same direction. The rotor 20 is subjected to forces oriented opposite to the respective Lorentz forces from the coil ends 101A and 106A. At this time, as the forces to which the rotor 20 is subjected from the coil ends 101A and 106A are of the same direction, they do not balance each other out. Consequently, a force vibrating the rotor 20 acts. FIG. 29C is an illustration when the comparison example is seen from the coil end side, and FIG. 29D is an illustration when the comparison example is seen from the right side. The comparison example differs in the size of forces F from the embodiment shown in FIGS. 29A and 29B.

Meanwhile, in the fourth embodiment shown in FIGS. 29A and 29B, and the heretofore known example shown in FIGS. 29C and 29D, the orientations of the forces to which the rotor 20 is subjected from the coil ends 101A and 106A are the same. However, in the fourth embodiment, as the magnetic member 210 is included, the number of magnetic flux lines 202A and 207A in the coil ends is smaller. Consequently, it is more difficult for the rotor 20 to vibrate in the fourth embodiment. That is, by including the magnetic member 210, it is possible to curb the vibration of the rotor 20. There are three pairs of electromagnetic coils 100 sandwiching the permanent magnets 200, and the Lorentz forces F, and Lorentz forces F2 and F3, generated in the respective pairs are oriented offset from each other by 120 degrees. Herein, it is ideal that the sizes of the Lorentz forces F, F2, and F3 are the same, but in the actual motor, they are slightly different from each other, and this can cause the vibration of the rotor 20.

In the embodiment, a description has been given using the inner rotor type motor, but an outer rotor type motor may be used.

### Fifth Embodiment

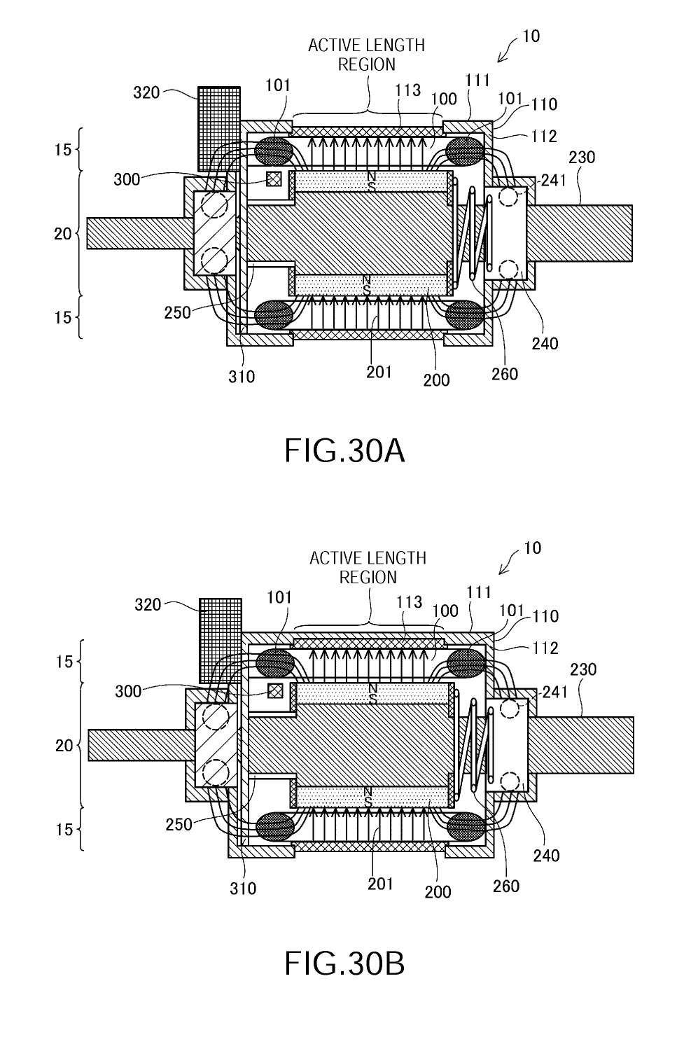

FIGS. 30A and 30B are illustrations showing a fifth embodiment. In the fifth embodiment, aluminum, or an aluminum alloy, with a superior thermal conductivity is used as a material of a casing 110. The embodiment shown in FIG. 30A is a partial casing wherein portions of the casing 110 not coinciding with the active length region 113 are formed from aluminum or an aluminum alloy, and the example shown in FIG. 30B is a full-coverage casing wherein the whole of the casing 110 including the active length region 113 is formed from aluminum or an aluminum alloy.

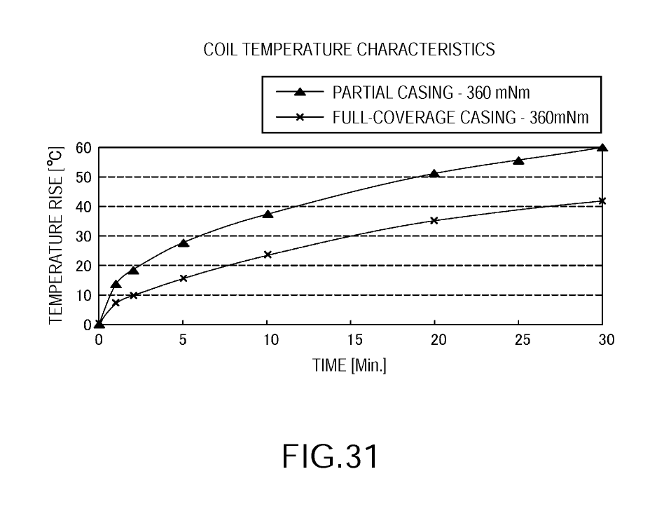

FIG. 31 is an illustration showing changes in temperature of the partial casing and full-coverage casing. As is clear from FIG. 31, it is more difficult for the temperature to rise in the full-coverage casing than in the partial casing. This can be thought to be for the following reason. In the case of the partial casing (FIG. 30A), as an insulating film is formed between stacked steel plate materials, it is difficult for heat to be conducted in a direction in which the steel plates are stacked. Consequently, it is difficult for heat generated in the active length region 113 to be transmitted to disc-shaped portions 112. Meanwhile, in the case of the full-coverage casing (FIG. 30B), the radial direction outer side of the active length region 113 is covered with aluminum or an aluminum alloy. For this reason, heat generated in the active length region 113 is transmitted to the disc-shaped portions 112 via an aluminum or aluminum alloy portion on the radial direction outer side of the active length region 113. Consequently, it is easier for the heat to be transmitted to the disc-shaped portion 112 in the full-coverage casing than in the partial casing, and it is possible to release the heat in a wide area.

### Sixth Embodiment

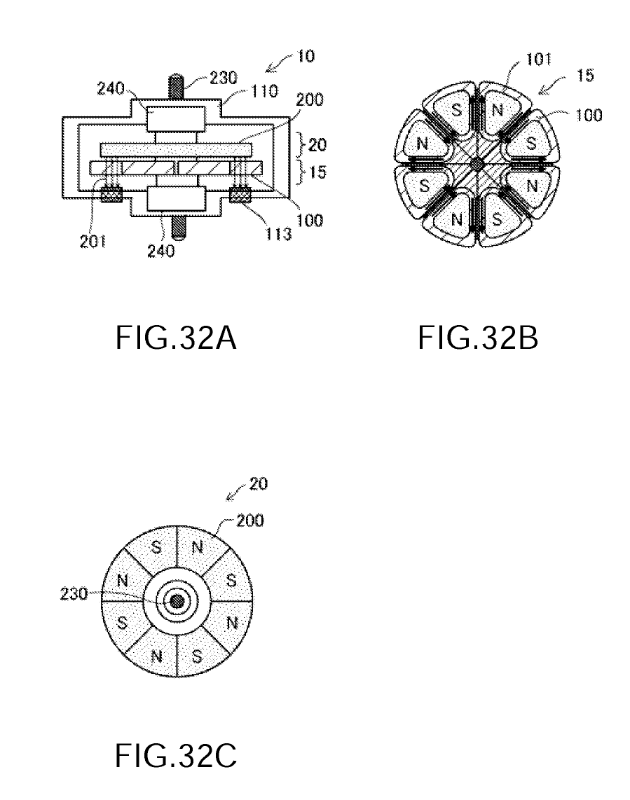

Also, in the above description, a description has been given taking the motor of the radial gap structure as an example, but a motor of an axial gap structure is also applicable in the same way. FIGS. 32A to 32C are illustrations showing a configuration of an axial gap type motor which is a sixth embodiment. A rotor 20 and a stator 15 have a first and second disc form perpendicular to a rotating shaft 230 of the rotor 20. Then, permanent magnets 200 and electromagnetic coils 100 are disposed, opposed to each other, on the opposed disc surfaces of the rotor 20 and stator 15. The motor has a magnetic member in a projection region (an active length region 113) when magnetic flux lines 201 are projected toward the electromagnetic coils 100 from the permanent magnets 200. In the case of the axial gap structure, the active length region 113, having a holed disc form, is provided in an end face portion. The active length region 113 may overlap a portion between two coil ends included in the electromagnetic coils 100, a first coil end and a second coil end, or may overlap a projection region when the magnetic flux lines 201 are projected in a direction parallel to the rotating shaft 230 while the permanent magnets 200 are being rotated.

### Seventh Embodiment

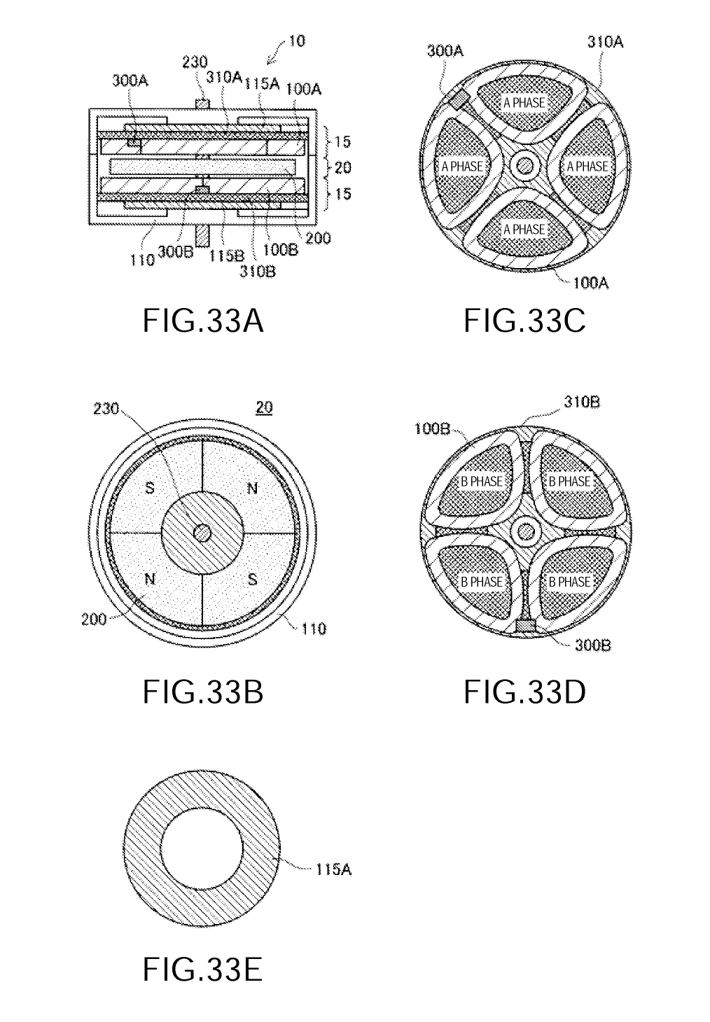

FIGS. 33A to 33E are illustrations showing a seventh embodiment. The seventh embodiment is an axial gap type motor. FIG. 33A shows a sectional view of an axial gap type motor 10 (hereafter also simply called a “motor 10”) taken on a plane parallel to a rotating shaft 230. FIG. 33B shows a plan view of a rotor, FIG. 33C shows a plan view of electromagnetic coils 100A, FIG. 33D shows a plan view of electromagnetic coils 100B, and FIG. 33E shows a plan view of a coil back yoke 115A. The seventh embodiment has approximately the same configuration as that of the axial gap type motor described in the sixth embodiment, excepting several differing points. Therefore, in the following description, components of the same configuration as those of the sixth embodiment are given the same reference numerals and characters, and a description is omitted.

The following are points differing from those of the sixth embodiment. The motor 10 of the seventh embodiment includes the A phase-use electromagnetic coils 100A, a magnetic sensor 300A, a circuit substrate 310A, the B phase-use electromagnetic coils 100B, a magnetic sensor 300B, and a circuit substrate 310B. That is, the motor 10 of the sixth embodiment includes two electromagnetic coils, two magnetic sensors, and two circuit substrates, one each for the A phase use and B phase use. Herein, the suffixes A and B of each reference numeral are for distinguishing between the A phase use and B phase use. In FIGS. 33C and 33D, the magnetic sensor 300A is disposed in a coil of the electromagnetic coils 100A, and the magnetic sensor 300B is disposed in a coil of the electromagnetic coils 100B, but it is also acceptable that the A phase magnetic sensor 300A is disposed in a coil of the electromagnetic coils 100B, and that the B phase magnetic sensor 300B is disposed in a coil of the electromagnetic coils 100A. Also, the seventh embodiment includes the coil back yokes 115A and 115B in place of the active length region 113. That is, with respect to the coil back yokes too, the motor 10 of the seventh embodiment includes the A phase-use one and B phase-use one. When the A phase-use coil back yoke 115A and B phase-use coil back yoke 115B are not distinguished from one another, they are simply called the “coil back yoke 115”. Also, the number of electromagnetic coils 100A (100B) and number (four) of permanent magnets 200 of the seventh embodiment differ from the number of electromagnetic coils 100 and number (eight) of permanent magnets 200 of the sixth embodiment, but in general, a motor can employ various numbers as these numbers depending on the intended use.

The coil back yoke 115A, having a holed disc form, is disposed on a side of the electromagnetic coils 100A opposite to the permanent magnets 200. It is preferable that the coil back yoke 115A is, for example, a magnetic member configured of a magnetic material. Also, the coil back yoke 115A, as well as being a magnetic member, may be a conductive member. Magnetic fluxes from the permanent magnets 200 pass through the inner side of the electromagnetic coils 100, and easily pass through the coil back yoke 115A. Herein, on the rotor 20 rotating, the permanent magnets 200 also rotate. Because of this, the magnetic fluxes passing through the coil back yoke 115A active length region 113 change, and a current generating magnetic fluxes in a direction in which the change of the magnet fluxes is impeded, that is, an eddy current, is generated. On the eddy current flowing, a power loss (an eddy-current loss) occurs, and is released as heat. The same also applies to the coil back yoke 115B. Also, in the embodiment, unlike the sixth embodiment, the motor includes the coil back yokes 115A and 115B separately from and independently of a casing 110, but the coil back yokes 115A and 115B may be configured integrally with the casing 110.

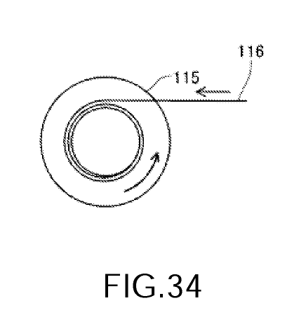

FIG. 34 is an illustration showing a manufacturing method of the coil back yoke 115. With the manufacturing method, the coil back yoke 115 is formed by coiling a long and thin flat plate 116 into a spiral spring form. The width of the flat plate 116 at this time is the thickness of the coil back yoke 115. With the coil back yoke 115 having a spiral spring form structure, as a radial direction resistance increases due to the resistance between the stacked portions of the flat plate 116, it is possible to reduce a radial direction current. Consequently, it is possible to curb a radial direction eddy current. With the coil back yoke 115 having the spiral spring form structure, an insulant may be applied to the surface of the flat plate 116. In this case, an insulant exists in portions of the coil back yoke 115 between the stacked portions of the flat plate 116, meaning that it is possible to further curb the radial direction current.

### Eighth Embodiment

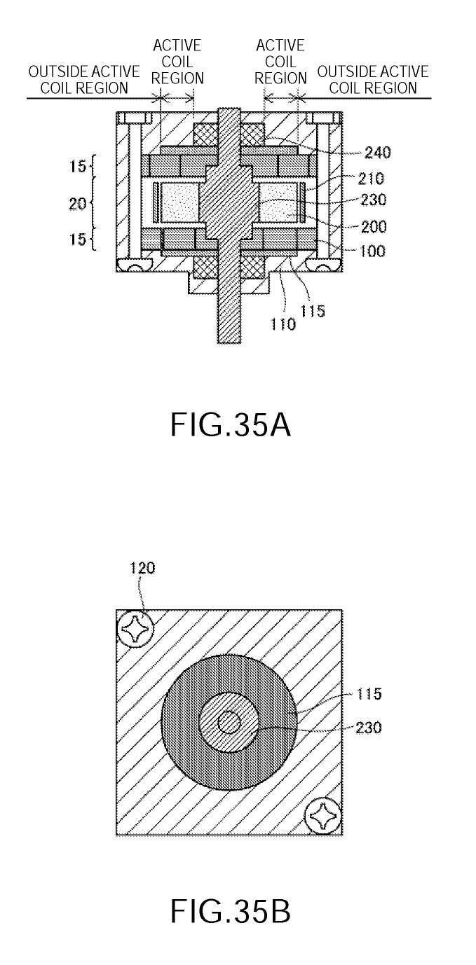

FIGS. 35A and 35B are illustrations showing an eighth embodiment. The eighth embodiment is an axial gap type motor. FIG. 35A shows a sectional view of the axial gap type motor 10 (hereafter also simply called the “motor 10”) taken on a plane parallel to a rotating shaft 230. FIG. 35B is a diagram of the motor 10 seen from a direction parallel to the rotating shaft.

A rotor 20 and a stator 15 have a disc form perpendicular to the rotating shaft 230 of the rotor 20. The rotor 20 includes permanent magnets 200, a side yoke 210, and the rotating shaft 230. The permanent magnets 200 are disposed on the periphery of the rotating shaft 230, in the same way as that shown in FIGS. 33A to 33E, and the orientation of magnetization is of a direction parallel to the rotating shaft 230. The side yoke 210 is disposed on the radial direction outer side of the permanent magnets 200.

The stator 15 includes electromagnetic coils 100, coil back yokes 115, bearings 240, and a casing 110. The electromagnetic coils 100 are wound along a plane perpendicular to the rotating shaft 230 (refer to FIG. 33C or 33D). The permanent magnets 200 and electromagnetic coils 100 are disposed, opposed to each other, on the opposed disc surfaces of the rotor 20 and stator 15. The coil end portions of the electromagnetic coils 100 protrude from the permanent magnets 200, and do not overlap the permanent magnets 200. Regions which do not overlap the coil ends of the electromagnetic coils 100 are also called “active coil regions”, in the same way as in the first embodiment, and regions which overlap the coil ends are called “regions outside motion”. The coil back yokes 115 are disposed on either side of the electromagnetic coils 100 opposite to the permanent magnets 200. The coil back yokes 115, having a holed disc form, overlap the active coil regions. The casing 110, having a thermal conductivity, is in contact with the coil back yokes 115, and discharges heat generated in the coil back yokes 115 due to an eddy-current loss to the exterior.

According to the embodiment, it is possible to easily discharge the heat generated in the coil back yokes 115 due to the eddy-current loss through the casing 110. Also, the coil back yokes 115 may be the kind of one shown in FIGS. 25A to 25C wherein an elongated plate is coiled into a spiral spring form. It is possible to reduce an eddy current in the coil back yokes 115, and curb the heat generation due to the eddy-current loss.

### Ninth Embodiment

FIGS. 36A to 36D are illustrations showing coil back yoke configuration examples. A coil back yoke 115 shown in FIG. 36A is the coil back yoke fabricated by the method shown in FIG. 34. FIG. 36B shows a coil back yoke including a cutaway portion 115S in one surface. When the coil back yoke is disposed in the motor 10, the coil back yoke 115 is disposed in such a way that the cutaway portion 115S is positioned on a surface side adjacent to the electromagnetic coils 100A (100B). The coil back yoke 115 can be manufactured by making a cut in the coil back yoke 115 shown in FIG. 36A using, for example, a wire electric discharge machine. FIG. 36C shows a coil back yoke having a cutaway portion 115C wherein the cutaway portion 115S reaches the other surface. The coil back yoke 115 can also be manufactured by, for example, a punching press, apart from making a cut in the coil back yoke 115 shown in FIG. 36A using, for example, a wire electric discharge machine. FIG. 36D shows a coil back yoke including a plurality of cutaway portions 115S in one surface. In this case, it is preferable that the plurality of cutaway portions 115S are provided in positions rotationally symmetric to each other. The cutaway portion 115S and cutaway portion 115C may be mixed. However, it is preferable that there is one cutaway portion 115C reaching the other surface. This is because, in the event that there are a plurality of cutaway portions 115C reaching the other surface, the coil back yoke 115 is divided into two or more.

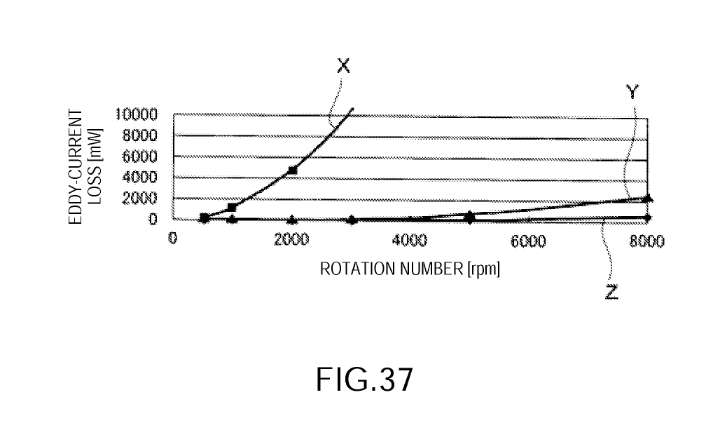

FIG. 37 is a graph showing a relationship between the rotation number and eddy-current loss of the motor in the ninth embodiment. A measurement of the eddy-current loss is carried out by the method shown in FIG. 7. Herein, a line X shows a characteristic when the cutaway portion 115C is not provided in the coil back yoke 115 shown in FIG. 36A. A line Y shows a characteristic when the cutaway portion 115S is provided in the coil back yoke shown in FIG. 36B. A line Z shows a characteristic when the cutaway portion 115C is provided in the coil back yoke 115 shown in FIG. 36C. The eddy current is smaller when the cutaway portion 115S exists in the coil back yoke 115 (the line Y), and the eddy current is still smaller when the cutaway portion 115C reaching the other surface exists. It can be thought that this is for the following reason. The eddy current is generated in a direction perpendicular to the direction of magnetic fluxes, that is, in a planar direction of the coil back yoke 115. Herein, the cutaway portions 115S curb an eddy current in a circumferential direction of the disc form. Then, the cutaway portion 115C reaching the other surface blocks the eddy current in the circumferential direction of the disc form. Consequently, by providing the cutaway portions 115S and 115C, it is possible to reduce the eddy-current loss.

With the coil back yoke 115A, it is preferable that the cutaway portion 115S thereof is disposed in such a way as to be positioned on the side of the electromagnetic coils 100A. This is because it is easier for the eddy current to be generated on the side of the electromagnetic coils 100A, and when the cutaway portion 115S is on the side of the electromagnetic coils 100A, it is easy to curb the eddy current owing to the cutaway portion 115S.

### Tenth Embodiment

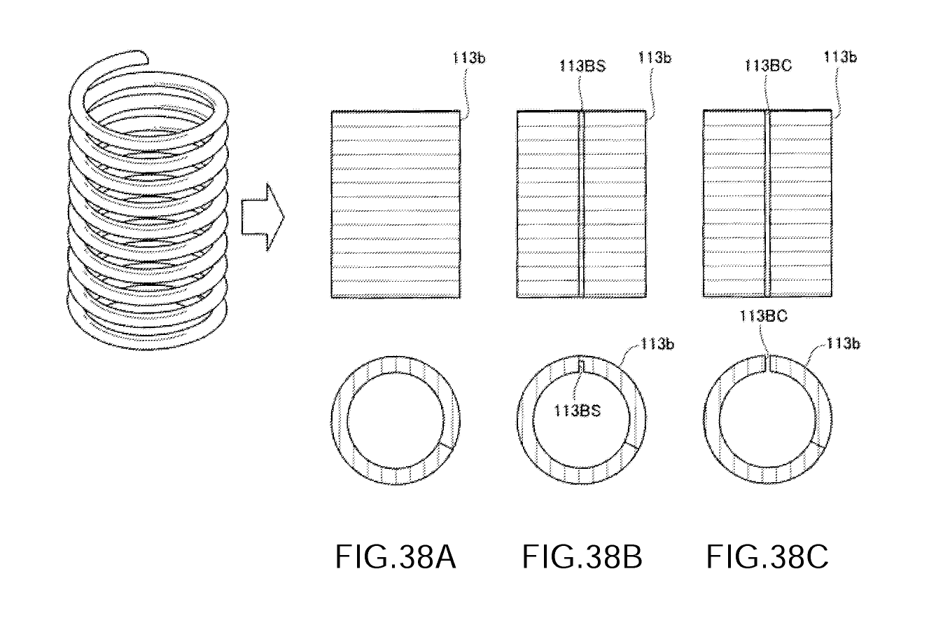

FIGS. 38A to 38C are illustrations showing a tenth embodiment. The tenth embodiment is such that a cutaway portion is provided in the cylindrical member 113 of the fourth embodiment, in the same way as in the ninth embodiment. A cylindrical member 113 of FIG. 38A is the cylindrical member shown in the fourth embodiment. FIG. 38B is such that a cutaway portion 113BS is provided on the inner wall side of the cylindrical member 113 of FIG. 38A. FIG. 38C is such that a cutaway portion 113BC reaching the outer wall from the inner wall is provided in the cylindrical member 113 of FIG. 38A. In this way, the cutaway portion 113BS or 113BC may be provided in the cylindrical member 113. Because of this, it is possible to curb the eddy current and reduce the eddy-current loss. In the embodiment, a description has been given taking the cylindrical member 113 formed by coiling a plate in a spiral form in the thickness direction as an example, but the cutaway portion 113BS or 113BC may be provided in a cylindrical member having a stacked structure wherein a large number of holed discs are stacked, or in a solid cylindrical member.

### Eleventh Embodiment

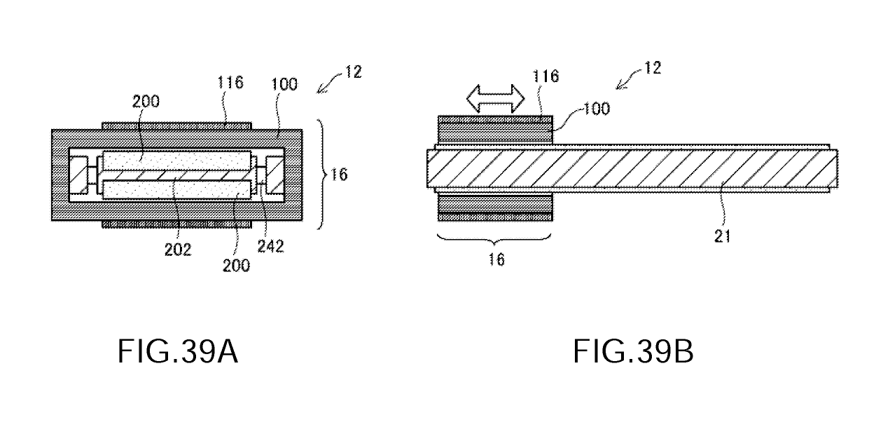

FIGS. 39A and 39B are illustrations showing an eleventh embodiment. The eleventh embodiment is a linear motor. The linear motor 12 includes a movable portion 16 and a fixed portion 21. The fixed portion 21 includes two magnets 200 and a magnet back yoke 202. The two magnets 200 are disposed in such a way as to sandwich the magnet back yoke 202. The orientation of magnetic fluxes of the two magnets 200 is such that the magnet back yoke 202 side is the south pole, and the outer side (the side opposite to the magnet back yoke 202) is the north pole. The north pole and south pole may be reversed. Also, the magnets 200 may include a slit parallel to a movement direction.

The movable portion 16 includes an electromagnetic coil 100 and a coil back yoke 116. The electromagnetic coil 100 is wound in a round direction with the movement direction of the movable portion as a central axis. The coil back yoke 116 is disposed on a side of the electromagnetic coil 100 opposite to the magnets 200. That is, the electromagnetic coil is positioned between the magnets 200 and coil back yoke 116. The coil back yoke 116 is configured by a plurality of plates being stacked, and the interface of the plurality of plates is parallel to the movement direction of the movable portion 16. It is possible to curb a generation of an eddy current occurring in the round direction with the movement direction of the movable portion as the central axis.

### Twelfth Embodiment

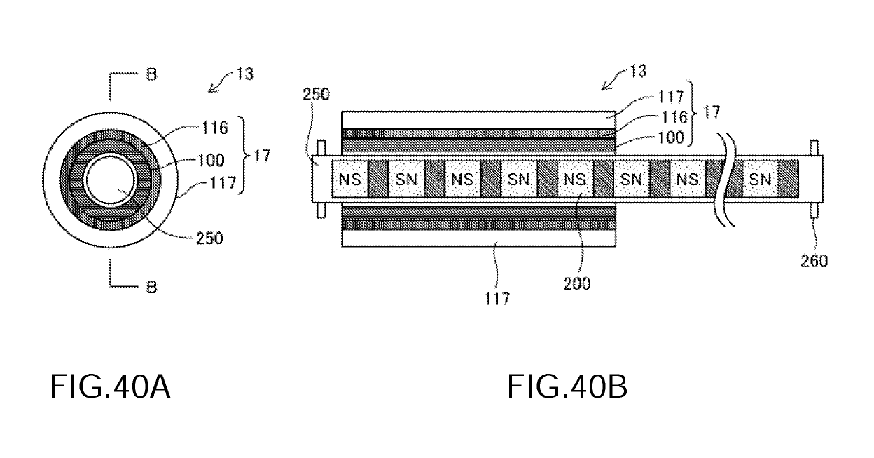

FIGS. 40A and 40B are illustrations showing a twelfth embodiment. The twelfth embodiment is a shaft motor 13. The shaft motor 13 includes a magnet shaft 205 and a movable body 17. The magnet shaft 205 includes magnets 200, a nonmagnetic casing 250, and stoppers 260. There are a plurality of the magnets 200, and they are disposed arranged in series in the nonmagnetic casing 250. The direction of magnetization of each magnet 200 is a length direction of the magnet shaft 205, and the orientations are alternated by 180 degrees. That is, adjacent magnets 200 have the same poles (the north poles or the south poles) facing each other. For this reason, two magnetic fluxes from the two magnets 200 repell each other. As a result, the orientation of the magnetic fluxes between the adjacent magnets 200 is a radial direction centered on the magnet shaft 205. The stoppers 260, being disposed at either end of the magnet shaft 205, act in such a way that the movable body 17 does not come off the magnet shaft 205.

The movable body 17 includes an electromagnetic coil 100, a coil back yoke 116, and a coil casing 117. The electromagnetic coil 100 is wound along the periphery of the magnet shaft 205. As the direction of magnetic fluxes of the magnets 200 is a radial direction centered on the magnet shaft 205, and the direction of a current flowing through the electromagnetic coil 100 is a direction along the periphery of the magnet shaft 205, the direction of a force to which the electromagnetic coil 100 is subjected is the length direction of the magnet shaft 205 in accordance with Fleming's left-hand rule. The coil back yoke 116 is disposed on the radial direction outer side of the electromagnetic coil 100. The coil back yoke 116 has a structure wherein rectangular plates, with the radial direction as a first side and the movement direction of the movable body 17 as a second side, are stacked to form a cylinder. Owing to the structure of the coil back yoke 116, it is possible to reduce an eddy current flowing along the circumference of the cylinder. The coil casing 117 is a casing which houses the electromagnetic coil 100 and coil back yoke 116.

### Thirteenth Embodiment

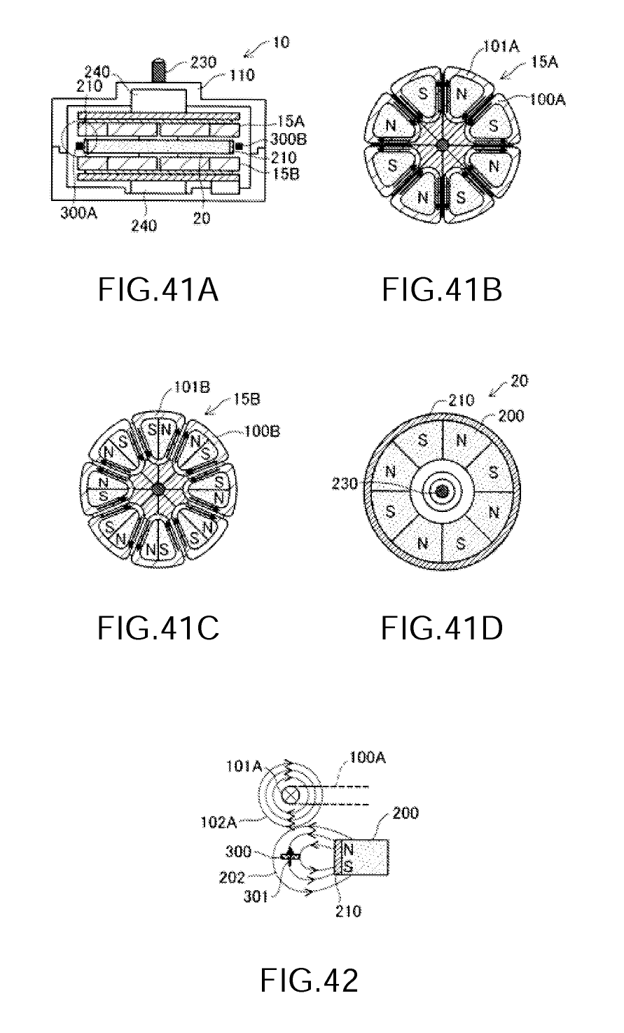

FIGS. 41A to 41D are illustrations showing a thirteenth embodiment. FIG. 41A is a sectional view showing a configuration of a coreless brushless motor in the thirteenth embodiment of the invention. The motor 10 has approximately disc-shaped first and second stators 15A and 15B, and an approximately disc-shaped rotor 20. The stators 15A and 15B and rotor 20 are housed in a casing 110.

FIGS. 41B and 41C are illustrations showing configurations of the stators 15A and 15B respectively. The stator 15A includes a plurality of electromagnetic coils 100A in each of which a lead is wound in a ring form. Herein, the “ring form”, not being limited to a round form, has a broad meaning including various forms such as an approximate sector form like that of the electromagnetic coils 100A of FIG. 41B and an elliptical form. The configuration of the stator 15B is the same as the configuration of the stator 15A.

FIG. 41D is an illustration showing a configuration of the rotor 20. The rotor 20 has eight permanent magnets 200 disposed in an annular form. The center of the rotor 20 is fixed to a rotating shaft 230. A direction of magnetization of the permanent magnets 200 is the up-down direction of FIG. 39A, and in FIG. 41D, a direction perpendicular to the plane thereof. A magnetic member 210 is provided on the periphery of the permanent magnets 200.

As shown in FIG. 41A, the rotor 20 is sandwiched by the stators 15A and 15B. Magnetic sensors 300A and 300B are disposed on either outer side of the rotor 20. The magnetic sensors are disposed in order to detect the position of the rotor 20. The first and second stators 15A and 15B, and the magnetic sensors 300A and 300B, are fixed to the casing 110 of the motor 10.

FIG. 42 is an illustration showing magnetic fluxes in the thirteenth embodiment. FIG. 42 is approximately the same as FIGS. 25A to 25C, and 27A and 27B. In the thirteenth embodiment too, the direction (the direction of an arrow 301) of magnetic fluxes detected by the magnet sensor 300 is perpendicular to the direction of magnetic fluxes 102A generated by a current flowing through a coil end 101A. Consequently, the output of the magnetic sensor 300 is not affected by the size of the current flowing through the coil end 101A. Also, as the magnetic member 210 is included between the magnetic sensor 300 and permanent magnet 200, it is difficult for the output of the magnetic sensor 300 to be saturated. Consequently, according to the second embodiment too, it is possible to curb a distortion or saturation occurring in the output of the magnetic sensor 300.

### Fourteenth Embodiment

In the first to third embodiments, a description has been given of the coreless motor 10 having the coil back yoke 115 having the stacked structure, and in the fourth embodiment, a description has been given of the coreless motor 10 wherein the magnetic sensor 300 is disposed in the position in which the direction of the magnetic fluxes generated by the electromagnetic coil 100 and the direction of the magnet fluxes detected by the magnetic sensor 300 are perpendicular to each other, and the magnetic material is disposed between the magnetic sensor 300 and permanent magnet 200. A fourteenth embodiment is a coreless motor having the characteristics of the two coreless motors.

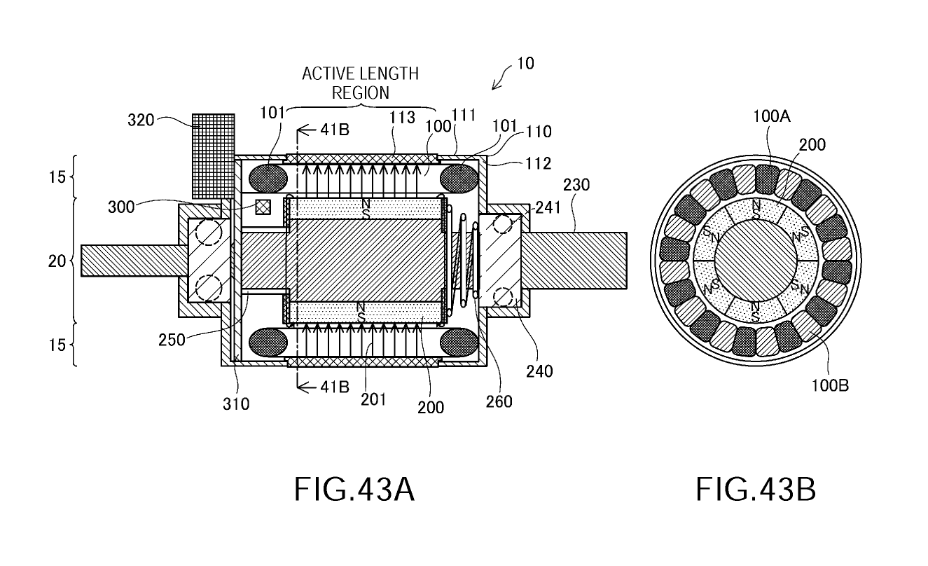

FIGS. 43A and 43B are illustrations schematically showing a configuration of a coreless motor of the fourteenth embodiment. Herein, FIG. 43A shows a section of the coreless motor 10 taken on a plane parallel to its rotating shaft, and FIG. 43B shows a section of the coreless motor taken on a plane (a cut plane 43B-43B) perpendicular to the rotating shaft. The coreless motor 10 is an inner rotor type motor of a radial gap configuration wherein an approximately cylindrical stator 15 is disposed on the outer side, and an approximately cylindrical rotor 20 is disposed on the inner side. The stator 15 has a plurality of electromagnetic coils 100A and 110B arranged along the inner periphery of a casing 110. The electromagnetic coils 100A and 100B are coreless (air-cored). The electromagnetic coils 100A and 100B in combination are also called the electromagnetic coils 100. Magnetic sensors 300 acting as position sensors which detect the phase of the rotor 20 are disposed one for each of the phases of the electromagnetic coils 100 (FIG. 43A). The magnetic sensors 300 are disposed on a perpendicular line extended down to the rotating shaft 230 side from a coil end 101 of the electromagnetic coils 100. The magnetic sensors 300 are connected to a circuit substrate 310, and the circuit substrate 310 is fixed to the casing 110.

The rotor 20, having the rotating shaft 230 in the center, has six permanent magnets 200 on the periphery. Each permanent magnet 200 is magnetized in a radial direction toward the exterior from the center of the rotating shaft 230. Also, the permanent magnets 200 and electromagnetic coils 100 are disposed, opposed to each other, on the opposed cylindrical surfaces of the rotor 20 and stator 15.

The rotating shaft 230 is supported by bearings 240 of the casing 110, and the bearings 240 include ball bearings 241. In the embodiment, the motor includes a coil spring 260 on an inner side of the casing 110. The coil spring 260, by pressing the permanent magnets 200 in the left direction of the drawing, carries out the positioning of the permanent magnets 200. However, the coil spring 260 can be omitted.

The casing 110 is configured of a cylindrical portion (a side surface portion) 111 parallel to the rotating shaft 230, and disc-shaped portions (end face portions) 112 which, being disposed at either end of the cylindrical portion 111, are perpendicular to the rotating shaft 230. The disc-shaped portions 112 are formed from a resin. The cylindrical portion 111 has a central portion 113 formed from a magnetic member and the remaining portions formed from a resin. The central portion 113, as it functions as a coil back yoke, is also called a “coil back yoke 113”. The coil back yoke 113 is disposed in a region of the casing 110 onto which the casing 110 is projected when the permanent magnets 200 are projected in a direction toward the electromagnetic coils 100 from the permanent magnets 200. As the coil back yoke 113 concentrates magnetic flux lines 201, it is easy for the magnetic flux lines 201 to pass inside the electromagnetic coils 100, and it is possible to improve the efficiency of the coreless motor 10. However, when it is easy for the magnetic flux lines 201 to pass, an eddy current is easily generated in the coil back yoke 113, as described hereafter.

In the embodiment, the coil back yoke 113, as well as being the magnetic member, is also a conductive member. As heretofore described, the coil back yoke 113 allows magnetic fluxes from the permanent magnets 200 and electromagnetic coils to pass through easily. Herein, on the rotor 20 rotating, the permanent magnets 200 also rotate. Because of this, the magnetic fluxes passing through the coil back yoke 113 change, and a current generating magnetic fluxes in a direction in which the change of the magnetic fluxes is impeded, that is, an eddy current, is generated. On the eddy current flowing, a power loss (an eddy-current loss) occurs, and is released as heat.

Herein, it is preferable that the coil back yoke 113 has a stacked structure the same as, for example, that of the coil back yoke 115 shown in FIG. 5, or that of the coil back yoke 115b shown in FIG. 6. By including this kind of stacked structure, it is possible to curb the eddy current in a direction parallel to the rotating shaft 230, and it is possible to curb the power loss due to the eddy-current loss, improve the efficiency of the coreless motor, and realize a high torque.

The coil back yoke 113 may be of a configuration including the cutaway portion 113BS or 113BC, as shown in FIGS. 38A to 38C. Because of this, it is possible to curb the eddy current, and reduce the eddy-current loss.

Next, a description will be given, referring to FIGS. 24B and 24C, of a direction in which the magnetic sensor 300 detects magnetic fluxes. A direction 301 in which the magnetic sensor 300 detects magnetic fluxes in the fourteenth embodiment, being the same as that of the fourth embodiment shown in FIG. 24A to 24C, is a direction parallel to the radial direction toward the outside from the center of the rotating shaft 230. Also, this detection direction 301 is the direction perpendicular to the magnetic fluxes 102A and 102B generated by the current flowing through the coil end 101. Consequently, even in the event that the size of the current flowing through the magnetic coil 100 changes, and the number of magnetic flux lines 102A and 102B changes, no change occurs in the output of the magnetic sensor 300.

Also, in the fourteenth embodiment, in the same way as in the fourth embodiment, a magnetic member 210 is provided between the permanent magnet 200 and magnet sensor 300. The magnetic member 210 may be configured from, for example, a soft magnetic body. As the magnetic member 210 allows the magnetic fluxes to pass through easily, provided that the number of magnetic flux lines emitted from the permanent magnet 200 is the same, the number of magnetic flux lines 202A and 202B protruding outside the magnetic member 210 decreases by the number of magnetic flux lines passing through the magnetic member 210. As a result of this, even in the event that the magnetic sensor 300 is disposed in proximity to the permanent magnet 200, it is difficult for the output of the magnetic sensor 300 to be saturated. As a result of this, it is possible to cause no distortion to occur in the output of the magnetic sensor 300, and curb an occurrence of saturation too. That is, even at the heavy load time, the output of the magnetic sensor 300 attains the kind of sinusoidal wave shown in FIG. 26D. In general, a motor is effective when it is driven with aback electromotive force waveform, that is, a sinusoidal wave. According to the fourteenth embodiment, as the magnetic sensor 300 is disposed in the position in which the direction of the magnetic flux lines generated by the electromagnetic coil 100 and the direction of the magnetic flux lines detected by the magnetic sensor 300 are perpendicular to each other, and the magnetic member 210 is disposed between the magnetic sensor 300 and permanent magnet 200, it is possible to curb the occurrence of the distortion or saturation in the output of the magnetic sensor 210, and output a clear sinusoidal wave. Then, by generating a drive signal of the coreless motor 10 using the output of the magnetic sensor, it is possible to efficiently drive this coreless motor 10, and it is possible to realize a high torque.

In the fourteenth embodiment, a description has been given of the radial gap type coreless motor 10, but an axial gap type coreless motor may be used.

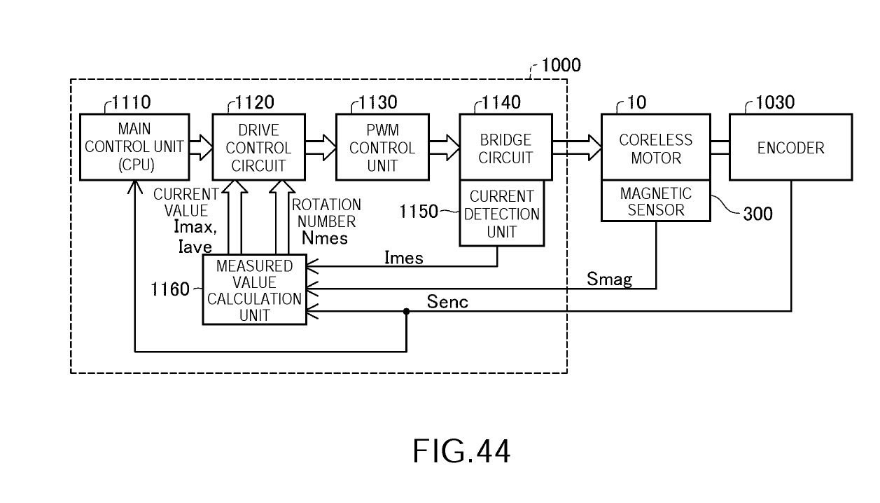

FIG. 44 is an illustration showing one example of a control block of a coreless motor. This motor system includes a control device 1000 and a coreless motor 10. The coreless motor 10 includes a magnetic sensor 300 and an encoder 1030 in order to detect the rotation angle (phase) of a rotor. The encoder 1030 can be omitted.

The control device 1000 includes a main control unit 1110 including a CPU, a drive control circuit 1120, a PWM control unit 1130, a bridge circuit 1140, a current detection unit 1150, and a measured value calculation unit 1160. The measured value calculation unit 1160 is a calculation circuit which calculates a maximum current value Imax and/or an average current value lave, and a motor rotation number Nmes, based on a detection current signal Imes output from the current detection unit 1150, a magnetic sensor signal Smag output from the magnetic sensor 300, and an encoder signal Senc output from the encoder 1030. It is preferable that the magnetic sensor signal Smag is a voltage waveform having a true similarity relationship with aback electromotive force waveform in which no distortion or saturation exists.

The drive control circuit 1120 and PWM control unit 1130 execute the control of the coreless motor 10 based on the maximum current value Imax and/or average current value lave, and on the motor rotation number Nmes. Specifically, the drive control circuit 1120 determines an adjustment value which adjusts a pulse width in a PWM control based on the maximum current value Imax and/or average current value Iave, and on the motor rotation number Nmes, and the PWM control unit 1130 generates a PWM control signal based on the adjustment value. The bridge circuit 1140 is an H bridge circuit configured of a plurality of switching elements, and a drive voltage is supplied to the electromagnetic coils 100 (for example, FIGS. 41A to 41D) of the coreless motor 10 from the bridge circuit 1140. By this means, the coreless motor 10 is driven. The current detection unit 1150 is a current sensor which measures a current (that is, a coil current of the coreless motor 10) flowing through the bridge circuit 1140.

### Modification Examples

The invention can be applied to various kinds of apparatus. For example, the invention can be applied to motors of various apparatus such as a fan motor, a timepiece (a needle drive), a drum type washing machine (a single rotation), a roller coaster, and a vibration motor. When the invention is applied to a fan motor, the heretofore described various advantages (low power consumption, low vibration, low noise, low rotation fluctuation, low heat generation, and long life span) are especially remarkable. This kind of fan motor can be used as a fan motor of various devices, for example, a digital display device, an on-vehicle device, a device using a fuel cell such as a fuel cell type personal computer, a fuel cell type digital camera, a fuel cell type video camera, or a fuel cell type portable telephone, and a projector. The motor of some aspects of the invention can be further utilized as a motor of various household electrical appliances and electronic devices too. The motor according to some aspects of the invention can be used as a spindle motor in, for example, an optical storage device, a magnetic storage device, or a polygon mirror drive device. Also, the motor according to some aspects of the invention can be utilized as a motor for use in a movable body or a robot.

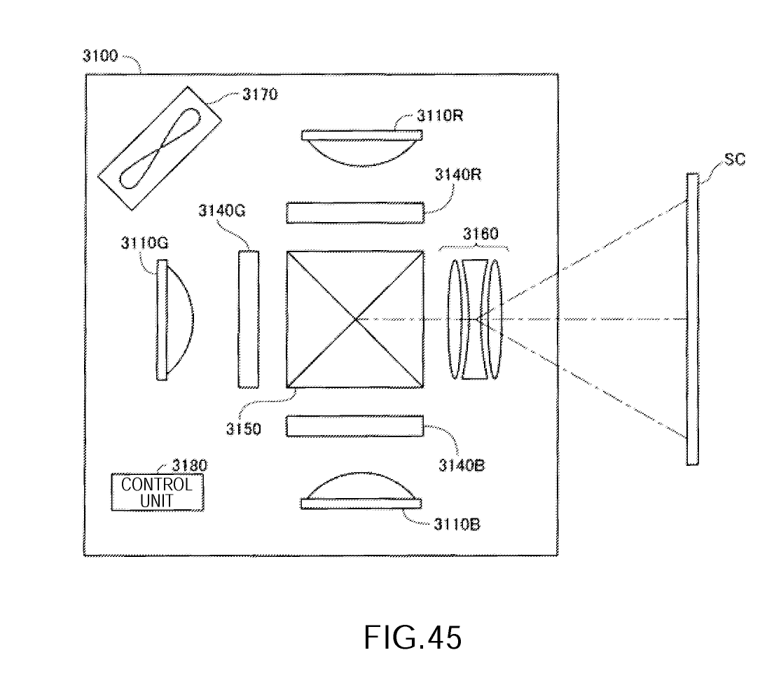

FIG. 45 is an illustration showing a projector utilizing a motor according to the modification example of the invention. The projector 3100 includes three light sources 3110R, 3110G, and 3110B which emit three color lights of red, green, and blue, three liquid crystal light valves 3140R, 3140G, and 3140B which modulate the three color lights respectively, a cross dichroic prism 3150 which synthesizes the three color lights modulated, a projection lens system 3160 which projects the three color lights synthesized onto a screen SC, a cooling fan 3170 for cooling the inside of the projector, and a control unit 3180 which controls the whole of the projector 3100. As a motor which drives the cooling fan 3170, it is possible to utilize each heretofore described kind of brushless motor.

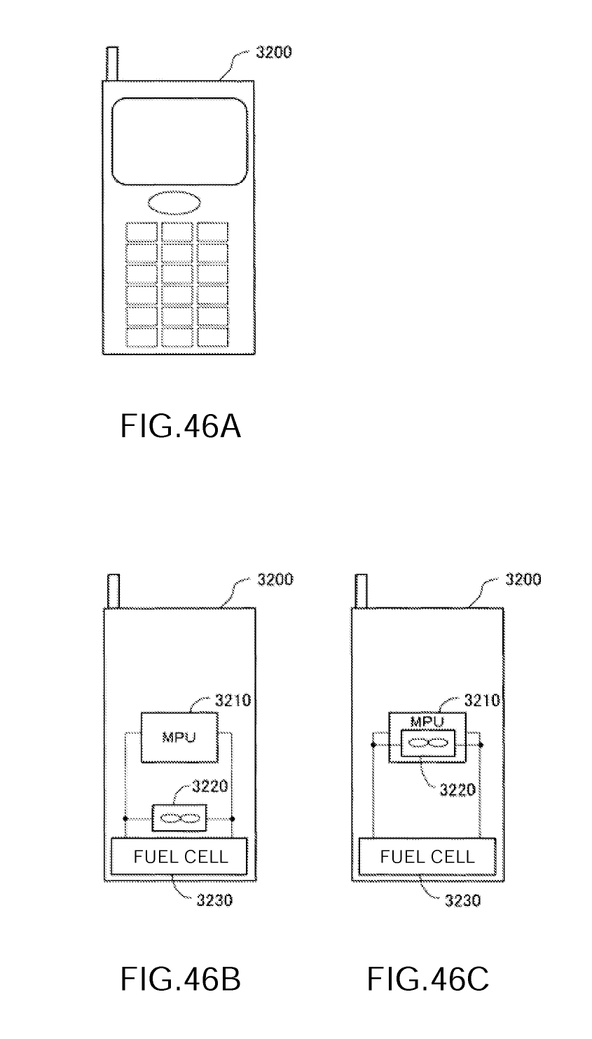

FIGS. 46A to 46C are illustrations showing a fuel cell type portable telephone utilizing a motor according to the modification example of the invention. FIG. 46A shows an external view of the portable telephone 3200, and FIG. 46B shows an example of an internal configuration. The portable telephone 3200 includes an MPU 3210 which controls the operation of the portable telephone 3200, a fan 3220, and a fuel cell 3230. The fuel cell 3230 supplies power to the MPU 3210 and fan 3220. The fan 3220 is for driving a current of air from the exterior to the interior of the portable telephone in order to supply the air to the fuel cell 3230, or for discharging water generated in the fuel cell 3230 to the exterior from the interior of the portable telephone 3200. An arrangement may be such that the fan 3220 is disposed on the MPU 3210, as in FIG. 46C, thus cooling the MPU 3210. As a motor which drives the fan 3220, it is possible to utilize each heretofore described kind of brushless motor.

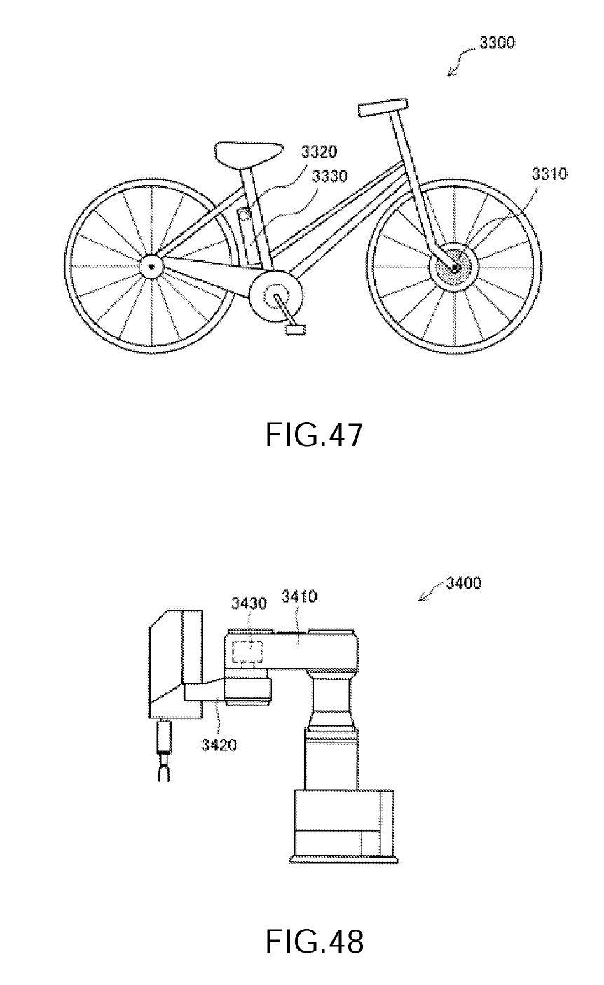

FIG. 47 is an illustration showing an electric bicycle (an electrically assisted bicycle) as one example of a movable body utilizing a motor/an electric generator according to the modification example of the invention. The bicycle 3300 is such that a motor 3310 is provided on the front wheel, and a control circuit 3320 and a rechargeable battery 3330 are provided on a frame below a saddle. The motor 3310 assists the bicycle in travelling by driving the front wheel utilizing power from the rechargeable battery 3330. Also, when braking, the rechargeable battery 3330 is charged with power regenerated by the motor 3310. The control circuit 3320 is a circuit which controls the drive and regeneration of the motor. As the motor 3310, it is possible to utilize each heretofore described kind of brushless motor.

FIG. 48 is an illustration showing one example of a robot utilizing a motor according to the modification example of the invention. The robot 3400 has a first and second arm 3410 and 3420, and a motor 3430. The motor 3430 is used when the second arm 3420 acting as a driven member is horizontally rotated. As the motor 3430, it is possible to utilize each heretofore described kind of brushless motor.

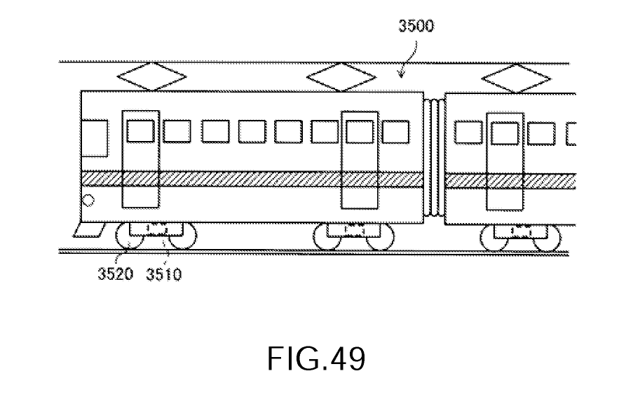

FIG. 49 is an illustration showing a railcar utilizing a motor according to the modification example of the invention. The railcar 3500 has motors 3510 and wheels 3520. The motors 3510 drive the wheels 3520. Furthermore, the motors 3510 are utilized as electric generators when the railcar is braked, thus regenerating power. As the motors 3510, it is possible to utilize each heretofore described kind of brushless motor.

Examples of the invention have heretofore been described based on several embodiments, but the heretofore described embodiments of the invention are for facilitating an understanding of the invention, and does not limit the invention. It goes without saying that the invention can be changed and improved without departing from the scope and claims of the invention, and that the invention includes any equivalent thereof.

This application claims priority to Japanese Patent Application No. 2010-120516 filed on May 26, 2010. The entire disclosure of Japanese Patent Application No. 2010-120516 is hereby incorporated herein by reference.

What is claimed is:

1. A coreless electromechanical device having a first and second member which are movable relative to each other, comprising:
a permanent magnet disposed on the first member;
an air-cored electromagnetic coil disposed on the second member; and
a coil back yoke which, being disposed on the second member, has a stacked structure, wherein
the electromagnetic coil is disposed between the permanent magnet and coil back yoke,
the electromagnetic coil has an active coil region, in which a force causing the first member to move relatively in a movement direction is generated in the electromagnetic coil, and coil end regions, and
the coil back yoke covers the active coil region, but does not cover the coil end regions.

2. The coreless electromechanical device according to claim 1, wherein
the active coil region is a projection region when the permanent magnet is projected toward the electromagnetic coil from the permanent magnet.

3. The coreless electromechanical device according to claim 1, wherein
the coil back yoke has a plurality of steel plate materials stacked in a direction perpendicular to the movement direction of the first member.

4. The coreless electromechanical device according to claim 3, wherein
the thickness of the steel plate materials is 0.1 mm or less.

5. The coreless electromechanical device according to claim 3, wherein
the thickness of the steel plate materials is approximately 0.1 mm.

6. The coreless electromechanical device according to claim 1, wherein
the first member further has a magnetic member, and
the second member further has a magnetic sensor which detects the size of magnetic fluxes generated by the permanent magnet, wherein
the magnetic sensor is disposed in a position in which a direction of magnetic flux lines generated by the magnetic coil and a direction of magnetic flux lines detected by the magnetic sensor are perpendicular to each other, and
the magnetic member is disposed between the magnetic sensor and permanent magnet.

7. The coreless electromechanical device according to claim 6, wherein
the first member and second member have a concentric cylindrical form with a rotating shaft of the first member as the center,
the permanent magnet and electromagnetic coil are disposed, opposed to each other, on the opposed cylindrical surfaces of the first member and second member, and
the magnetic member is disposed on an end face of the permanent magnet in a direction parallel to an axial direction of the rotating shaft.

8. The coreless electromechanical device according to claim 7, wherein
a position in which the magnetic sensor is disposed is between a coil end of the electromagnetic coil and the rotating shaft, and on a radial line extended down to the rotating shaft from the coil end.

9. The coreless electromechanical device according to claim 1, wherein
the permanent magnet includes side yokes at either end in a direction perpendicular to each of the direction toward the electromagnetic coil from the permanent magnet and the movement direction.

10. The coreless electromechanical device according to claim 1, wherein
the first member is a rotor having the permanent magnet, and
the second member is a stator having the air-cored electromagnetic coil, the coil back yoke, and a casing, wherein
the rotor and stator have a concentric cylindrical form with a rotating shaft of the rotor as the center,
the permanent magnet and electromagnetic coil are disposed, opposed to each other, on the opposed cylindrical surfaces of the rotor and stator, and
the coil back yoke is provided in a projection region of the casing when the permanent magnet is projected in the direction toward the electromagnetic coil from the permanent magnet, and the coil back yoke is not provided outside the projection region of the casing.

11. The coreless electromechanical device according to claim 10, wherein
the projection direction is a radial direction centered on the rotating shaft.

12. The coreless electromechanical device according to claim 10, wherein
the coil back yoke has a cylindrical form, and
the cylindrical form is formed by stacking holed discs.

13. The coreless electromechanical device according to claim 10, wherein
the coil back yoke has a cylindrical form, and
the cylindrical form is formed by coiling a plate having a thickness smaller than its width in a spiral form in a direction of the thickness.

14. The coreless electromechanical device according to claim 12, wherein
the coil back yoke has a cutaway portion in a side surface of the cylindrical form on the electromagnetic coil side.

15. The coreless electromechanical device according to claim 14, wherein
the cutaway portion reaches a side surface of the cylindrical form on the side opposite to the electromagnetic coil.

16. The coreless electromechanical device according to claim 6, wherein
the first member and second member have a first and second disc form perpendicular to the rotating shaft of the first member,
the permanent magnet and electromagnetic coil are disposed, opposed to each other, on the opposed disc surfaces of the first member and second member, and
the magnetic member is disposed on an end face of the permanent magnet in a direction perpendicular to the axial direction of the rotating shaft.

17. The coreless electromechanical device according to claim 16, wherein
a position in which the magnetic sensor is disposed is on a straight line drawn parallel to the rotating shaft from the coil end of the electromagnetic coil.

18. The coreless electromechanical device according to claim 1, wherein
the first member is a rotor having the permanent magnet, and
the second member is a stator having the air-cored electromagnetic coil, the coil back yoke, and a casing, wherein
the rotor and stator have a first and second disc form perpendicular to a rotating shaft of the rotor,
the permanent magnet and electromagnetic coil are disposed, opposed to each other, on the opposed disc surfaces of the rotor and stator, and
the coil back yoke is provided in a projection region of the casing when the permanent magnet is projected in the direction toward the electromagnetic coil from the permanent magnet, but the coil back yoke is not provided outside the projection region of the casing.

19. The coreless electromechanical device according to claim 18, wherein
the projection direction is a direction parallel to the rotating shaft.

20. The coreless electromechanical device according to claim 16, wherein
the coil back yoke has a holed disc form, and
the holed disc form is formed by coiling a long and thin flat plate in a spiral spring form.

21. The coreless electromechanical device according to claim 20, wherein
the holed disc form has a cutaway portion in a surface on the electromagnetic coil side.

22. The coreless electromechanical device according to claim 21, wherein
the cutaway portion reaches a surface of the holed disc form on the side opposite to the electromagnetic coil.

23. The coreless electromechanical device according to claim 1, wherein
the coil back yoke is exposed to the external air.

24. The coreless electromechanical device according to claim 1, wherein
the coil back yoke contains 5 or more percent by weight of silicon.

25. The coreless electromechanical device according to claim 1, wherein
the first member has a rod-like structure having a magnet inside it,
the second member, having an electromagnetic coil wound in a round direction with the first member as an axis, moves along the first member, and
the coil back yoke has a stacked structure having layers parallel to the movement direction of the second member.

26. The coreless electromechanical device according to claim 6, wherein
the magnetic member is provided on a side surface in the movement direction of the permanent magnet in such a way that, when the permanent magnet moves relative to the electromagnetic coil, the output waveform of the magnetic sensor becomes a waveform equivalent to a waveform wherein a back electromotive force waveform occurring in the electromagnetic coil is normalized,
the magnetic sensor detects magnetic fluxes leaking from the magnetic member, and
the electromagnetic coil is PWM driven in accordance with the output waveform of the magnetic sensor.

27. A coreless electromechanical device comprising:
a rotor having a permanent magnet and a magnetic member;
a stator having an active coil region in which a force causing the rotor to rotate is generated and coil end regions, and having an electromagnetic coil which is air-cored and a magnetic sensor which detects the size of magnetic fluxes generated by the permanent magnet;
a coil back yoke which covers the active coil region but does not cover the coil end regions; and
a casing which surrounds the rotor, stator, and coil back yoke, wherein
the magnetic sensor is disposed in a position in which a direction of magnetic flux lines generated by the electromagnetic coil and a direction of magnetic flux lines detected by the magnetic sensor are perpendicular to each other,
the magnetic member is disposed between the magnetic sensor and permanent magnet,
the active coil region is a projection region when the permanent magnet is projected toward the electromagnetic coil from the permanent magnet, and
the coil back yoke is formed by stacking steel plate materials with a thickness of 0.1 mm or less parallel to a rotation direction of the rotor.
